(19) United States
(12) Patent Application Publication
(10) Pub. No.: US 2026/0273528 A1
(43) Pub. Date: Sep. 17, 2026

(54) MICROFLUIDIC SAMPLE HANDLING

(71) Applicant: Vital Biosciences Inc., Mississauga (CA)

(72) Inventors: Vitali BORISENKO, Richmond Hill (CA); Laura PIÑEROS, Scarborough (CA)

(21) Appl. No.: 19/162,506

(22) PCT Filed: Mar. 9, 2024
(86) PCT No.: PCT/IB2024/052282

§ 371 Date: Sep. 5, 2025

Related U.S. Application Data
(60) Provisional application No. 63/489,424, filed on Mar. 10, 2023.
(60) Provisional application No. 63/489,681, filed on Mar. 10, 2023.

(51) Int. Cl. B01L 3/00

(52) U.S. Cl. CPC B01L 3/502738; B01L 2200/027; B01L 2300/165; B01L 2400/0406; B01L 2400/0409; B01L 2400/0688

(57) ABSTRACT

Structures, devices and methods for handling fluids are provided. A valve includes a first channel having a first inlet connected to an upstream chamber. The first inlet of the first channel has a cross-section perpendicular to a flow direction that is the same as or smaller than the upstream chamber and thus forms a hydrophobic junction with the upstream chamber at the first inlet. The valve also includes a compartment connected to a first outlet of the first channel. The compartment has a cross-section perpendicular to the flow direction that is larger than the first outlet of the first channel, and thus forms a hydrophilic junction at the first outlet of the first channel.

### TECHNICAL FIELD

The present application claims priority to U.S. Provisional Patent Application No. 63/489,424 filed Mar. 10, 2023 and U.S. Provisional Patent Application No. 63/489,681 filed Mar. 10, 2023. The disclosure of each application is incorporated herein for all purposes by reference in its entirety.

### TECHNICAL FIELD

The present disclosure relates to devices and methods for handling fluids, and in particular, to devices and methods for handling fluids in microfluidics.

### BACKGROUND

Currently, 70% of all medical decisions rely on lab based diagnostics but today, the diagnostic process is disjointed from how care is delivered. The primary care system requires patients to travel to external phlebotomy sites to draw blood which is sent to labs via courier, and processed overnight. This means that lab results reach health care professionals long after the patient has left. This friction in care delivery and disease management leads to tremendous waste in the healthcare system:
a. Patients often delay getting lab tests or fail to adhere to lab testing, or subsequent care recommendations
b. The gap in the diagnostic process leads to missed tests, missed diagnosis, a lack of intervention, and ultimately poor outcomes
c. Health care professionals waste time tracing lab orders to patient encounter notes. When intervention is needed, more time is wasted in reaching out to patients and driving subsequent steps in the patient's care pathway.

These problems are even more acute when caring for rural populations or patients belonging to groups facing adverse social-determinants of health, where there are many challenges in ensuring successful follow ups from an initial patient encounter.

Several companies have built point-of-care instruments to bridge this divide. However, these instruments are limited to single types of tests and fail to completely meet the workflow needs of primary care providers for a single system that produces simple, comprehensive, and fast test results. A product to meet these needs is currently under development. It achieves this through a highly automated workflow enabled through the use of centrifugal microfluidics discs.

Centrifugal microfluidics are used in clinical chemistry, immunoassays, hematology, medicine, biomedical research and other fields. These applications often require metering, transferring, mixing fluids and/or other processes. Many of these applications also require detection of concentrations and reactions. However, achieving effective control on the metering, transferring and mixing of the fluids and precise measurement of concentrations and reactions can be a challenge in microfluidics, because the behavior of liquids can be significantly different from their bulk counterparts due to the small scales involved.

Accordingly, there remains a need for improved devices and methods in centrifugal microfluidics to address these and other needs in the art.

### SUMMARY

In a first aspect, the present disclosure provides a simple and reliable valve that integrates both hydrophobic and hydrophilic principles into a single simple structure and eliminates the need for surface treatments. The valve includes a first channel and a compartment. The first channel has a first inlet and a first outlet. The first inlet is connected to an upstream chamber and has a cross-section perpendicular to a flow direction that is the same as or smaller than the upstream chamber, thereby forming a hydrophobic junction with the upstream chamber at the first inlet. The compartment is connected to the first outlet of the first channel. The compartment has a cross-section perpendicular to the flow direction that is larger than the first outlet of the first channel, thereby form a hydrophilic junction at the first outlet of the first channel.

In some embodiments, the compartment is deeper, wider or both than the first channel. In some embodiments, the compartment is cylindrical. In some such embodiments, the compartment has a circular, oval, oblong, or polygonal cross-section.

In some embodiments, the valve further includes a second channel having a second inlet and a second outlet. The second inlet is connected to the compartment and the second outlet is connected to a downstream chamber. In an embodiment, the second channel has a cross-section perpendicular to the flow direction the same as the first channel. In another embodiment, the second channel has a cross-section perpendicular to the flow direction different than the first channel. In some embodiments, the second channel is longer than the first channel.

In a second aspect, the present disclosure provides a device including a valve disclosed herein, and an upstream chamber. In some embodiments, a portion of the upstream chamber adjacent to the first inlet of the first channel of the valve is tapered to smooth transition between the upstream chamber and the first inlet of the first channel of the valve.

In some such embodiments, the tapered portion of the upstream chamber has a trapezoidal cross-section parallel to the flow direction. In some embodiments, the tapered portion of the upstream chamber is configured based at least in part on a fluid to be processed by the device. In some embodiments, the tapered portion of the upstream chamber has an angle of about −10 to −30 degrees, about −30 to −60 degrees, or about −60 to −80 degrees with respect to the first channel.

In a third aspect, the present disclosure provides a device having a structure for entrapping leftover fluid. The device is rotational around a rotational axis. The device includes a channel for transferring a fluid by rotating the device around the rotational axis. The channel includes an inlet, an outlet radially outwards of the inlet with respect to the rotational axis and a first portion between the inlet and outlet. The device also includes a structure connected to a first side of the first portion of the channel. The structure is configured to (i) allow transferring of the fluid when the device rotates at a first speed, (ii) collect fluid residue when the device rotates at a second speed that is greater than the first speed, and (iii) entrap the collected fluid residue within the structure when the device is subjected to an acceleration, a deceleration, or both.

In some embodiments, the structure includes a pocket for containing the fluid residue and a chamber connecting the pocket to the first side of the first portion of the channel. The chamber has a depth greater than the first portion of the channel and the pocket, thereby acting as a valve between the first portion of the channel and the pocket.

In some embodiments, at least a portion of the structure is positioned radially outwards of the first portion of the channel, and a radially innermost point on a junction formed by the chamber and the first side of the first portion of the channel defines a maximum permissible level for the fluid residue. In some embodiments, a second side of the first portion of the channel is positioned radially inwards of the maximum permissible level for the fluid residue. In some embodiments, the first portion of the channel is bent.

In a fourth aspect, the present disclosure provides a device for mixing a fluid with two or more different components by inertia. The device is rotational around a rotational axis. The device includes a mixing chamber having a curved side that is not coaxial with the rotational axis and configured for mixing a fluid with two or more different components by inertia.

In a fifth aspect, the present disclosure provides a method for mixing a fluid with two or more different components by inertia. The method includes (A) obtaining a device including a rotational axis and a mixing chamber with a curved side that is not coaxial with the rotational axis, wherein the mixing chamber contains a fluid including two or more different components. In some embodiments, a volume of the fluid is at most 50%, at most 55%, at most 60%, at most 65% or at most 70% of the mixing chamber.

The method also includes (B) accelerating the device to a first speed in a direction towards the curved side of the mixing chamber. In some embodiments, the first speed is based at least in part on a type of the fluid, an amount of the fluid, a shape of the mixing chamber, or any combination thereof.

The method further includes (C) decelerating abruptly the device such that the fluid moves towards the curved side of the mixing chamber due to inertia. The curved side of the mixing chamber translates the movement of the fluid into a circular motion that produces vortices, thereby promoting mixing of the two or more different components in the fluid. In some embodiments, the decelerating (C) is performed at a deceleration of at least 500 rpm/s, at least 1000 rpm/s, at least 1500 rpm/s, at least 2000 rpm/s, or at least 2500 rpm/s, at least 3000 rpm/s, at least 5000 rpm/s, 10000 rpm/s, at least 50000 rpm/s, or greater. In some embodiments, the decelerating (C) brings the device to a full stop.

In some embodiments, the method further includes (D) repeating the accelerating (B) and the decelerating (C) for one or more times.

In some embodiments, the mixing chamber includes a pathway at a side opposite to the curved side and not coaxial with the rotational axis. In some such embodiments, the method further includes (E) accelerating slowly the device at a second speed in a direction towards the pathway, and (F) decelerating abruptly the device such that the fluid moves towards the pathway of the mixing chamber due to inertia. In some embodiments, the second speed is based at least in part of a type of the fluid, an amount of the fluid, a shape of the mixing chamber, or any combination thereof.

In a sixth aspect, the present disclosure provides a method for directing fluid flow by inertia. The method includes (A) obtaining a device having a rotational axis and a chamber having a pathway that is not coaxial with the rotational axis, wherein the chamber contains a fluid, (B) accelerating the device in a direction towards the pathway of the chamber, and (C) decelerating abruptly the device such that the fluid moves towards the pathway of the chamber due to inertia.

In a seventh aspect, the present disclosure provides a capillary channel capable of bubble-free priming. The capillary channel includes an open end and a dead end positioned radially outwards of the open end with respect to a rotational axis. The capillary channel also includes first, second and third lanes. The first lane has an inlet at the open end for receiving a fluid. The third lane has an outlet at the open end for venting air. The second lane is formed between and connected to the first and third lanes. The second lane has a flow resistance different than the first and third lanes, thereby allowing the fluid to flow first through the first lane from the open end to the dead end and then flow through the second lane, the third lane or both from the dead end to the open end to facilitate bubble-free priming.

In some embodiments, the first, second and third lanes collectively form a stepwise cross-section perpendicular to a length direction of the capillary channel. In some embodiments, the first and third lanes are deeper than the second lane. In an embodiment, the first and third lanes are substantially the same as each other. In another embodiment, the first and third lanes are different from each other. In some embodiments, at least two of the first, second and third lanes have a same width. In some embodiments, at least two of the first, second and third lanes have a different width.

In an eighth aspect, the present disclosure provides a device rotatable around a rotational axis. The device includes a vent port, and a capillary channel disclosed herein. The capillary is positioned radially outwards of the vent port, with the outlet of the third lane of the capillary channel connected to the vent port.

In a ninth aspect, the present disclosure provides a device having a pinched structure for directing fluid flow. The device includes a chamber, and a channel connected to the chamber for delivering a fluid to the chamber. The chamber and channel collectively form a junction that minimizes or eliminates capillary flow when the fluid exits from an outlet of the channel into the chamber. In some embodiments, the junction allows the fluid to flow from the outlet of the channel into the chamber in a direction of a centrifugal force.

In some embodiments, the channel includes a protruding portion that forms at least a portion of the junction. In an embodiment, the protruding portion includes a U-shaped wall on each side of the channel at the outlet of the channel. In another embodiment, the protruding portion includes a V-shaped wall on each side of the channel at the outlet of the channel. In some embodiments, a wall of the chamber adjacent to the outlet of the channel is curved radially inward relative to the outlet of the channel to form at least a portion of the junction.

In a ninth aspect, the present disclosure provides a method for measuring depths with self-calibration capability. The method includes (A) obtaining a device including a structure filled with an absorbing dye. The structure includes a first portion having a first depth and a second portion having a second depth. The first and second depths are different from each other but the nominal depth difference between the first and second depths is known. In some embodiments, the obtaining (A) includes obtaining the device with the structure and filling the structure with the absorbing dye.

The method also includes (B) measuring a first optical density of the absorbing dye at the first portion of the structure and a second optical density of the absorbing dye at the second portion of the structure, and (C) calculating an optical density difference between the first and second optical densities. The method further includes (D) calculating a ratio of the optical density difference to the nominal depth difference. The ratio represents a product of an extinction coefficient and a concentration of the absorbing dye. In addition, the method includes (E) using the ratio to determine the first depth of the first portion of the structure, the second depth of the second portion of the structure, a depth of any additional structure of the device, or any combination thereof.

In a tenth aspect, the present disclosure provides a device for measuring depths with self-calibration capability. The device includes one or more structures, each including a first portion having a first depth and a second portion having a second depth. The first and second depths are different from each other but a nominal depth difference between the first and second depths is known, thereby allowing self-calibration of a depth of any structure of the device independent of variations in manufacturing the device.

In some embodiments, the one or more structures includes a first structure and a second structure at different locations of the device. In an embodiment, the nominal depth difference of the first structure is the same as the second structure. In another embodiment, the nominal depth difference of the first structure is different than the second structure.

In an eleventh aspect, the present disclosure provides a method for measuring concentration despite of manufacturing variability. The method includes (A) obtaining a device including a structure located in a pathway of a mixture having a first component. The structure includes a first portion having a first depth and a second portion having a second depth. The first and second depths are different from each other but the nominal depth difference between the first and second depths is known. In some embodiments, the first component is hemoglobin.

The method also includes (B) measuring a first optical density of the first component at the first portion of the structure and a second optical density of the first component at the second portion of the structure. In some embodiments, the measuring of absorbance is performed using a spectrophotometer or a microfluidics device.

The method further includes (C) calculating an optical density difference between the first and second optical densities, and (D) determining a concentration of the first component in the mixture based at least in part on the optical density difference and the nominal depth difference. In some embodiments, the concentration of the first component in the mixture is determined by comparing the optical density difference with a calibration curve at an optical pathway corresponding to the nominal depth difference. In some embodiments, an extinction coefficient of the first component is known, and the concentration of the first component in the mixture is calculated by dividing the optical density difference with the nominal depth difference and the extinction coefficient of the first component.

In some embodiments, the method further includes (E) creating, prior to the determining (D), the calibration curve. In some embodiments, the creating (E) includes (i) preparing a series of standard solutions with known concentrations of the first component, (ii) measuring absorbance of each of the standard solutions at one or more specific wavelengths for the first component at one or more optical pathways, thereby obtaining a plurality of absorbance values, and (iii) plotting the absorbance values against the corresponding concentrations of the first component to create the calibration curve for each of the one or more optical pathways.

In a twelfth aspect, the present disclosure provides a device for measuring concentration despite of manufacturing variability. The device includes a structure located in a pathway of a mixture having a first component. The structure includes a first portion having a first depth and a second portion having a second depth. The first and second depths are different from each other but the nominal depth difference between the first and second depths is known, thereby allowing measurement of a concentration of the first component independent of variations in manufacturing the device.

The devices, systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the invention. The accompanying drawings are not necessarily to scale. The specific design features of the present invention as disclosed herein, including, for example, specific dimensions, orientations, locations, and shapes will be determined in part by the particular intended application and use environment. In addition, the components illustrated in the figures are combinable in any useful number and combination.

In the drawings:

FIG. 1A is a schematic diagram illustrating a device including a valve, where the valve is in a hydrophobic scenario, in accordance with some exemplary embodiments of the present disclosure;

FIG. 1B is a schematic diagram illustrating the device of FIG. 1A, where the valve is in a hydrophilic scenario, in accordance with an exemplary embodiment of the present disclosure;

FIG. 1C is a schematic diagram illustrating a cross-sectional view of the device taken along the dotted line in FIG. 1A;

FIG. 1D is a schematic diagram illustrating a cross-sectional view of the device in accordance with an alternative exemplary embodiment of the present disclosure;

FIG. 1E is a schematic diagram illustrating an existing hydrophobic valve;

FIG. 1F is a schematic diagram illustrating an existing hydrophilic valve;

FIG. 2A is an image showing a device having a structure for entrapping leftover fluid in accordance with some exemplary embodiments of the present disclosure;

FIG. 2B is a schematic diagram illustrating a structure for entrapping leftover fluid in accordance with some exemplary embodiments of the present disclosure;

FIG. 2C is a cross-sectional view taken along the vertical line in FIG. 2B;

FIG. 2D is an image showing a device without the structure for entrapping leftover fluid;

FIG. 3 is a flow chart illustrating a method for mixing a fluid with two or more different components by inertia in accordance with some exemplary embodiments of the present disclosure;

FIG. 4A is an image showing a device for mixing a fluid with two or more different components by inertia in accordance with an exemplary embodiment of the present disclosure;

FIG. 4B is an image showing a device for mixing a fluid with two or more different components by inertia in accordance with an alternative exemplary embodiment of the present disclosure;

FIG. 4C is an image showing a device for mixing a fluid with two or more different components by inertia in accordance with another alternative exemplary embodiment of the present disclosure;

FIG. 4D is an image showing a device for mixing a fluid with two or more different components by inertia in accordance with a still another alternative exemplary embodiment of the present disclosure;

FIG. 5 is a flow chart illustrating a method for directing fluid flow by inertia in accordance with some exemplary embodiments of the present disclosure;

FIG. 6 is an image showing a device for directing fluid flow by inertia in accordance with some exemplary embodiments of the present disclosure;

FIG. 7A is an image showing a device having a capillary channel capable of bubble-free priming in accordance with some exemplary embodiments of the present disclosure;

FIG. 7B is a cross-sectional view illustrating the capillary channel of FIG. 7A in accordance with some exemplary embodiments of the present disclosure;

FIG. 8A is an image showing a device having a pinched structure for directing fluid flow in accordance with some exemplary embodiments of the present disclosure;

FIG. 8B is a schematic diagram illustrating the pinched structure of FIG. 8A in accordance with an exemplary embodiment of the present disclosure;

FIG. 8C is a schematic diagram illustrating the pinched structure of FIG. 8A in accordance with an alternative exemplary embodiment of the present disclosure;

FIGS. 8D and 8E are images showing devices without a pinched structure for directing fluid flow;

FIG. 9 is a flow chart illustrating a method for measuring depths with self-calibration capability in accordance with some exemplary embodiments of the present disclosure;

FIG. 10A is an image showing a device having a structure for measuring depths with self-calibration capability in accordance with some exemplary embodiments of the present disclosure;

FIG. 10 B is a cross-sectional view illustrating the structure of FIG. 10A in accordance with some exemplary embodiments of the present disclosure;

FIG. 11 is a flow chart illustrating a method for measuring concentration despite of manufacturing variability in accordance with some exemplary embodiments of the present disclosure;

FIG. 12A is an image showing a device having a structure for measuring concentration despite of manufacturing variability in accordance with some exemplary embodiments of the present disclosure;

FIG. 12 B is a cross-sectional view illustrating the structure of FIG. 12A in accordance with some exemplary embodiments of the present disclosure;

FIG. 13 is a schematic diagram illustrating a device (e.g., a disc) in accordance with some exemplary embodiments of the present disclosure;

FIG. 14 is a schematic diagram illustrating a device (e.g., a disc) in accordance with some exemplary embodiments of the present disclosure;

FIG. 15 is a block diagram illustrating a workflow in accordance with some exemplary embodiments of the present disclosure;

FIG. 16A-1 is a schematic diagram and FIG. 16A-2 is a photograph illustrating a buffer loading process in accordance with some exemplary embodiments of the present disclosure;

FIG. 16B-1 is a schematic diagram and FIG. 16B-2 is a photograph illustrating a sample loading process in accordance with some exemplary embodiments of the present disclosure;

FIG. 16C-1 is a schematic diagram and FIG. 16C-2 is a photograph illustrating a buffer overflow process in accordance with some exemplary embodiments of the present disclosure;

FIG. 16D-1 is a schematic diagram and FIG. 16D-2 is a photograph illustrating a sample overflow process in accordance with some exemplary embodiments of the present disclosure;

FIG. 16E-1 is a schematic diagram and FIG. 16E-2 is a photograph illustrating a sample metering process in accordance with some exemplary embodiments of the present disclosure;

FIG. 16F-1 is a schematic diagram and FIG. 16F-2 is a photograph illustrating a buffer metering process in accordance with some exemplary embodiments of the present disclosure;

FIG. 16G-1 is a schematic diagram and FIG. 16G-2 is a photograph illustrating a spinning accelerating process in accordance with some exemplary embodiments of the present disclosure;

FIG. 16H-1 is a schematic diagram and FIG. 16H-2 is a photograph illustrating a mixing process in accordance with some exemplary embodiments of the present disclosure;

FIG. 16I-1 is a schematic diagram and FIG. 16I-2 is a photograph illustrating a first measurement process in accordance with some exemplary embodiments of the present disclosure;

FIG. 16J-1 is a schematic diagram and FIG. 16J-2 is a photograph illustrating a second measurement process in accordance with some exemplary embodiments of the present disclosure;

FIG. 16K-1 is a schematic diagram and FIG. 16K-2 is a photograph illustrating a third measurement process in accordance with some exemplary embodiments of the present disclosure;

FIG. 16L-1 is a schematic diagram and FIG. 16L-2 is a photograph illustrating a sample separation process in accordance with some exemplary embodiments of the present disclosure; and

FIG. 16M-1 is a schematic diagram and FIG. 16M-2 and FIG. 16M-3 are photographs illustrating a self-calibration process in accordance with some exemplary embodiments of the present disclosure.

### DETAILED DESCRIPTION

### Simplified And Reliable Valve Design

Microfluidic systems often require the use of valves to regulate fluid flow, but existing solutions have limitations such as requiring multiple components, complex fabrication processes, or surface treatments. For instance, known solutions often require multiple components and complex fabrication processes, which can increase the cost and complexity of device manufacture. Moreover, known solutions often require surface treatments, such as coatings, to achieve the necessary hydrophobicity or hydrophilicity for proper valve performance. These treatments can add an additional step to the manufacturing process and limit the range of materials that can be used. Further, known solutions are often limited in their applicability to certain materials or environmental conditions, and may only work well with hydrophobic or hydrophilic materials or may be sensitive to changes in temperature or humidity. In addition, known solutions often lack means to prevent sample drying (e.g., blood drying) and/or cell settling that may cause blockage of the microfluidic channels.

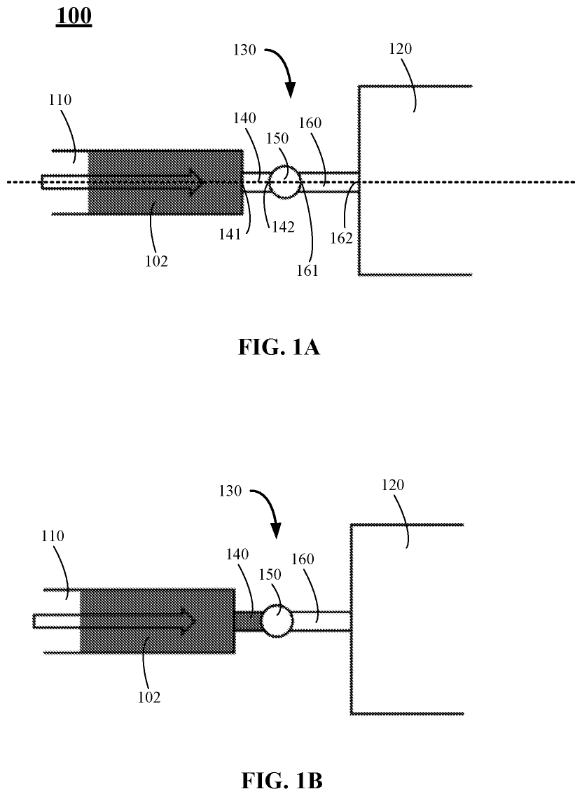

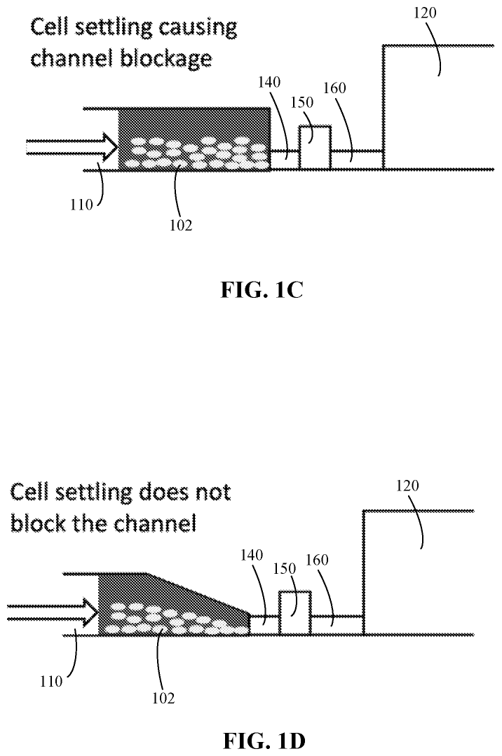

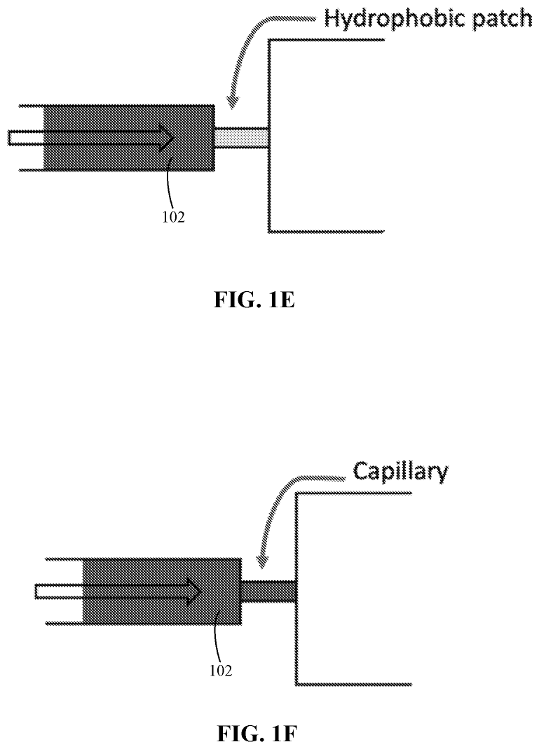

Hydrophobic materials repel water and do not allow it to spread out over their surfaces, whereas hydrophilic materials attract water and allow it to spread out over their surfaces. This results in the behavior where a liquid 102 would stop at the entrance of a narrow hydrophobic patch in a channel as illustrated in FIG. 1E and stop at the widening of a capillary channel if it is hydrophilic as illustrated in FIG. 1F.

Hydrophobic valves rely on the interaction between the liquid and the material of the valve disk to control the flow of liquid through a microfluidic channel. They are typically made of hydrophobic materials, such as certain plastics, to prevent the liquid from wetting the surface of the valve. A hydrophobic valve typically includes a constriction or a hydrophobic patch in the channel, which creates a pressure drop that prevents the liquid from flowing through the valve. To open the valve, the pressure of the liquid must be increased beyond a certain threshold to overcome the pressure drop and allow the liquid to flow through the valve. One advantage of hydrophobic valves is that they do not require surface treatments, such as hydrophobic coatings, to maintain their hydrophobicity. This makes them more cost-effective and easier to use than other types of valves, especially for large-scale production. Additionally, hydrophobic materials are relatively inert and chemically resistant, which makes them suitable for use in a wide range of applications, including those involving aggressive or corrosive liquids.

In the case of a hydrophilic material, the liquid would spread out and wet the surface, which would increase the total surface area in contact with the air, reducing the pressure and causing the liquid to move up the channel. Hydrophilic valves utilize the phenomenon of liquid meniscus pinning to control the flow of liquid through microfluidic channels. When a liquid comes into contact with a solid surface, it forms a meniscus that can be held at the point of maximum curvature, preventing further flow. By carefully designing the dimensions and geometry of the channel, the burst pressure can be controlled, and the valve can be triggered to open or close when the pressure exceeds a certain threshold. The burst pressure is determined by several factors, including the channel dimensions, surface tension, and contact angle of the liquid. The smaller the channel dimensions, the higher the surface tension required to maintain the liquid meniscus. Conversely, a larger channel will require less surface tension to maintain the meniscus. The contact angle of the liquid is also important because it determines how much the liquid will wet the surface of the channel, which in turn affects the strength of the liquid-solid interaction. Hydrophilic valves have numerous important applications in microfluidics and lab-on-a-chip devices, where they are used to precisely control the flow of liquids and to manipulate small volumes of fluids.

The stability of hydrophobic and hydrophilic valves can be affected by changes in the hydrophobicity or hydrophilicity of the materials used to make the valve, which can cause the valves to become less effective or even fail completely.

The present disclosure addresses these and/or other needs by providing a simple valve that is more effective and more reliable in controlling the flow of fluids, especially the fluids containing blood. The simple valve of the present disclosure integrates both hydrophobic and hydrophilic principles into a single simple structure and eliminates the need for surface treatments. This makes it easier and cost-effective to manufacture microfluidic devices and provides improved reliability and performance. In some embodiments, the simple valve of the present disclosure includes sections designed to prevent drying of the fluid and cell settling, which helps to ensure reliable valve performance even with thicker materials (e.g., thicker blood materials).

Referring now to FIGS. 1A-1C, there is shown a device 100 in accordance with some embodiments of the present disclosure. The device 100 includes an upstream chamber 110, a downstream chamber 120 and a valve 130 configured to connect the upstream and downstream chambers. The valve 130 generally includes a first channel 140 and a compartment 150. The first channel and the compartment are configured such that the first channel forms a hydrophobic junction with the upstream chamber, e.g., functioning as a hydrophobic valve, and the compartment forms a hydrophilic junction with the first channel, e.g., functioning as a hydrophilic valve.

For instance, in some embodiments, the first channel 140 has a first inlet 141 and a first outlet 142. The first inlet 141 is connected to the upstream chamber 110 and has a cross-section perpendicular to the flow direction that is the same as or smaller than the upstream chamber. As such, it forms a hydrophobic junction with the upstream chamber to stop a fluid at the first inlet of the first channel if it is hydrophobic. The compartment 150 is connected to the first outlet of the first channel, and has a cross-section perpendicular to the flow direction that is larger than the first outlet of the first channel. As such, it forms a hydrophilic junction to stop a fluid at the first outlet of the first channel if it is hydrophilic. In some embodiments, the compartment is deeper, wider or both than the first channel. In some embodiments, the compartment is cylindrical. In some embodiments, the compartment has a circular, oval, oblong, or polygonal cross-section.

Because the valve 130 integrates both hydrophobic and hydrophilic principles into a single structure, it is more stable and reliable with a wider operational range. For instance, it can regulate the flow of liquid even if one of the features becomes compromised. This can help to increase the overall reliability and stability of the valve, and to extend its operational range. Combining both hydrophobic and hydrophilic features in a single valve improves performance and allows a wider operational range compared to traditional hydrophobic or hydrophilic valves. In addition, it allows optimizing one or more dimensions (e.g., length, width, height) of the first channel and/or compartment, without any surface patterning, to ensure reliable operation of the valve in both types of conditions. For instance, in some specific implementations, the first channel may have a width of about 100 μm to about 200 μm, about 200 μm to about 300 μm, about 300 μm to about 400 μm, or about 400 μm to about 500 μm. The first channel may have a depth of about 100 μm to about 200 μm, about 200 μm to about 300 μm, about 300 μm to about 400 μm, or about 400 μm to about 500 μm. The first channel may have a length of about 200 μm to about 400 μm, about 400 μm to about 600 μm, about 600 μm to about 800 μm, or about 800 μm to about 1000 μm. However, the present disclosure is not limited thereto. For instance, depending on the applications, the first channel may be smaller, shorter, bigger or longer. It may have a width or depth that is at least 0.5 mm, at least 0.6 mm, at least 0.7 mm, at least 0.8 mm, at least 0.9 mm, or at least 1 mm. It may have a length that is at least 1 mm, at least 5 mm, at least 1 cm, at least 2 cm, at least 3 cm, at least 4 cm, or at least 5 cm.

The valve 130 can include additional, optional or alternative features. For instance, in some embodiments, the valve 130 includes a second channel 160 configured to prevent sample drying. In some embodiments, the second channel 160 connects the compartment to the downstream chamber, for instance, having a second inlet 161 connected to the compartment and a second outlet 162 connected to the downstream chamber.

The addition of the second channel can help to minimize sample (e.g., blood) evaporation, surface hydration, and/or humidity condensation in microfluidic systems. Sample evaporation, surface hydration, and/or humidity condensation can cause significant problems in microfluidic applications, including the loss of sample volume, channel clogging, the formation of surface contaminants, and the degradation of sample quality. For instance, blood drying is a major issue in blood analysis applications. Drying can lead to the formation of a barrier by red blood cells, causing valve malfunctioning and potentially affecting the accuracy of the analysis. The second channel can help to reduce these effects by providing a longer, more restricted path for the sample, which reduces the exposure of the sample to air and other environmental factors. This can help to slow down the rate of evaporation and surface hydration, and to prevent the formation of humidity condensation, thus helping to preserve the integrity and quality of the sample. Carefully controlling the exposure of the sample to the environment is crucial for the overall performance and reliability of the system.

The second channel may be configured the same as the first channel or differently from the first channel. For instance, in some embodiments, the second channel has a cross-section (e.g., the width and depth) perpendicular to the flow direction the same as the first channel. Alternatively, in some embodiments, the second channel has a cross-section perpendicular to the flow direction different than the first channel. In some typical embodiments, the second channel is longer than the first channel.

The optimization of length, width and/or depth of the second channel may depend on whether or not the channel is blocked upon evaporation. In some embodiments, the aspect ratios of the length over width and the length over the depth of the second channel is greater than 2, greater than 3, greater than 4, or greater than 5. For instance, in some specific implementations, the second channel has a length of about 1 mm to 5 mm and a width or depth of about 150 μm to about 400 μm. However, the present disclosure is not limited thereto. For instance, depending on the applications, the length of the second channel may reach several centimeters or more.

Referring to FIG. 1D, in some embodiments, the junction between the upstream chamber 110 and the valve entrance (e.g., the first inlet 141 of the first channel) are configured to reduce blockages due to cell settling. For instance, in some such embodiments, a portion 112 of the upstream chamber 110 adjacent to the first inlet of the first channel of the valve is tapered to smooth transition between the upstream chamber and the first inlet of the first channel of the valve. In some embodiments, the tapered portion of the upstream chamber has a trapezoidal cross-section parallel to the flow direction. In some embodiments, the tapered portion of the upstream chamber is configured based at least in part on the fluid 102 to be processed by the device. In some embodiments, the tapered portion of the upstream chamber has an angle of about −10 to −30 degrees, about −30 to −60 degrees, or about −60 to −80 degrees with respect to the first channel. However, the present disclosure is not limited thereto. Depending on the applications (e.g., the fluid to be processed), the portion 112 of the upstream chamber 110 can have different shapes, sizes, and/or angles.

The design of the junction between the upstream chamber (e.g., a blood sample compartment) and the valve entrance can play a critical role in preventing channel blockages due to cell settling. For instance, the use of a trapezoidal shape as illustrated in FIG. 1D, as opposed to a rectangular one illustrated in FIG. 1C, at the join can help to reduce the likelihood of channel blockage by reducing the sharpness of the transition between the upstream chamber and the first channel. The trapezoidal shape provides a smoother transition between the two parts and thus reduces the risk of cells getting trapped or settling at the junction, which can cause blockages. This can help to improve the overall performance and reliability of the valve, to maintain the flow of the sample through the channel, and to ensure that the valve functions as intended even with thicker blood materials.

The valve of the present disclosure has a number of advantages over the existing solutions. For instance, regarding complexity, existing solutions often require multiple components, complex fabrication processes, or surface treatments, which increases the complexity of the microfluidic device and makes it more difficult to manufacture and maintain. The valve of the present disclosure integrates both hydrophobic and hydrophilic principles into a single simple structure and thus reduces the number of components and fabrication steps needed. Regrading reliability, existing solutions may not be reliable enough for certain applications as they may become inefficient if the surface or sample properties change or if there is a delay between the time the sample reaches the valve and the time the sample passes the valve. The valve of the present disclosure combines simple sections in a single structure, and thus allows the valve to perform more reliably across a wider range of materials, samples and environmental conditions. Regrading cost, surface treatments and complex fabrication processes can be expensive, making the production of existing microfluidic devices cost-prohibitive for some applications. The valve of the present disclosure eliminates the need for surface treatments and thus reduces the cost of manufacturing microfluidic devices. Also, the passive nature of the valve, driven by the centrifugal force generated by the rotating speed of the device (e.g., cartridge), eliminates the need for external actuation and reduces the overall cost of manufacturing fluidic devices. Regarding evaporation and cell settling, existing solutions may not be effective in preventing sample drying (e.g., blood drying) or cell settling, which can result in a valve malfunctioning. The valve or the device of the present disclosure includes features (e.g., the second channel and the tapered portion of the upstream chamber) to prevent evaporation and cell settling, ensuring reliable valve performance even with thicker blood materials. In addition, the valve and the device of the present disclosure allow flexibility in material selection. The ability to use a wide range of materials for cartridge manufacturing, including both hydrophobic and hydrophilic materials, opens new possibilities for fluidic device design and fabrication. The valve and the device of the present disclosure may be adapted to different environmental conditions, such as temperature and humidity, and used in a wider range of applications.

Overall, the present disclosure provides a more effective solution to control fluid flow in microfluidic devices by simplifying the device design, improving reliability, reducing cost, and preventing evaporation and cell settling. The combination of these design features makes the valve and device of the present disclosure a significant advancement in the field of microfluidics and fluidic devices, offering potential benefits for a wide range of applications including but not limited to biomedical and clinical applications.

### Structure For Entrapping Leftover Fluid

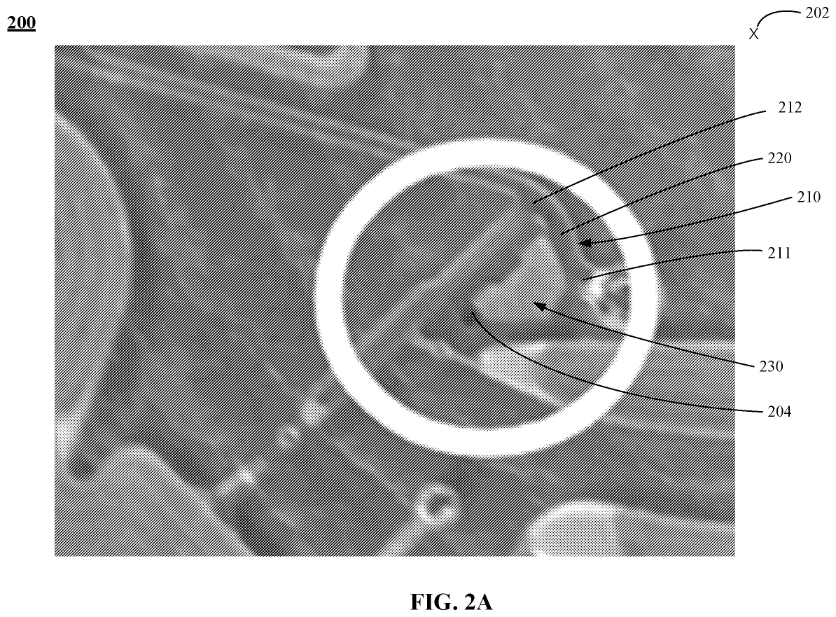

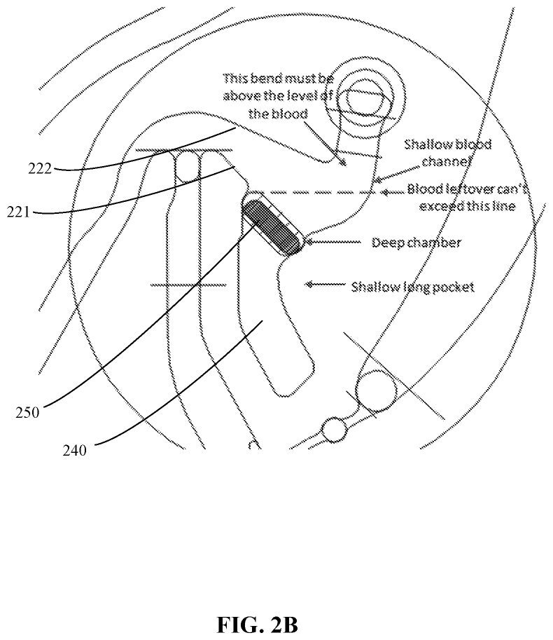

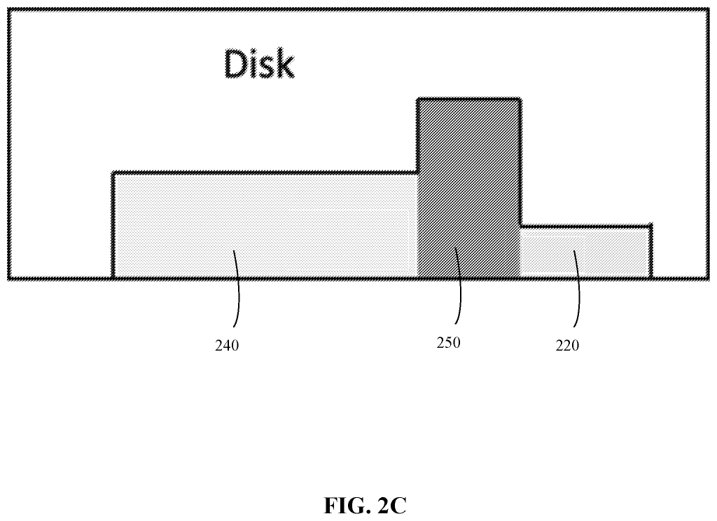

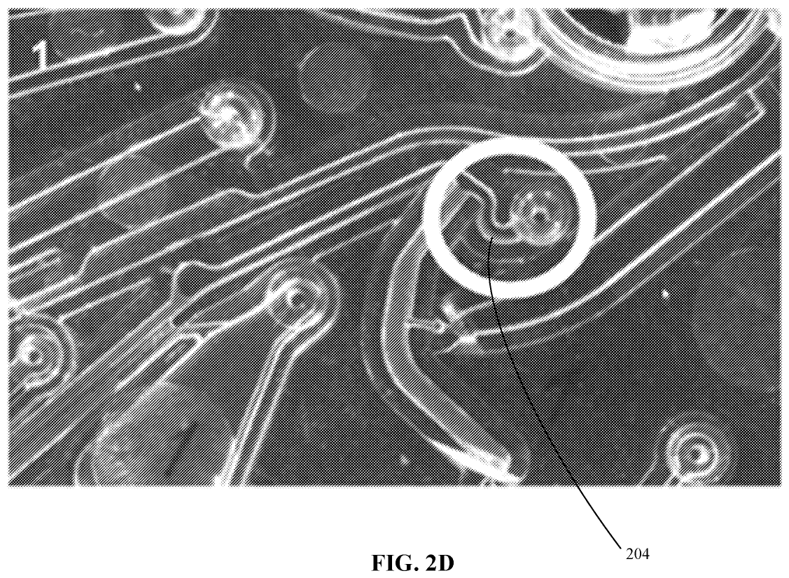

In many applications, leftover fluid (e.g., blood) 204 would be temporarily accumulated, for instance, at the bottom of a U-shape channel as illustrated in FIG. 2D. The leftover fluid, however, is not fully trapped, and would be pulled into a downstream chamber (e.g., a metering chamber) in subsequence processes due to its high viscosity and/or other factors. In addition, the temporarily accumulated fluid can block the access to an air vent, causing the negative pressure to build up that would result in an uncontrollable fluid movement. A general solution would be adding a long and deep U-shape structure. However, there is not enough room on the disk to accommodate such a structure, and a significantly larger volume of fluid (e.g., blood) will be required. There is also a chance that for very thick samples, the dragging force would not be able to pull the blood without breaking it apart. This may cause the blockage of the channel and buildup of a negative pressure. The present disclosure addresses these and/or other needs by providing a structure that can not only entrap the leftover liquid but also allow control of the fluid flow.

Referring to FIGS. 2A-2C, there is shown a device 200 in accordance with some embodiments of the present disclosure. The device 200 is rotatable around a rotational axis 202. The device includes a channel 210 for transferring a fluid by rotating the device around the rotational axis. The channel 210 includes an inlet 211 and an outlet 212 positioned radially outwards of the inlet with respect to the rotational axis. The channel 210 also includes a first portion 220 between the inlet and outlet. The first portion has a first side 221 (e.g., a side of the channel at the first portion) and a second side 222 (e.g., another side of the channel at the first portion). In some embodiments, the first portion of the channel may be bent. In some embodiments, the first side 221 may be positioned generally radially outward of its corresponding second side 222. In some embodiments, the first side 221 has a general concave shape and/or the second side 222 has a convex shape with respect to the interior of the first portion of the channel.

The device 200 also includes a structure 230 connected to the first side 221 of the first portion 220 of the channel. The structure 230 is configured to (i) allow transferring of the fluid when the device rotates at a first speed, (ii) collect fluid residue (e.g., leftover fluid) when the device rotates at a second speed that is greater than the first speed, and (iii) entrap the collected fluid residue within the structure when the device is subjected to an acceleration, a deceleration, or both.

For instance, in some embodiments, the structure 230 includes a pocket 240 for containing the fluid residue and a chamber 250 for connecting the pocket to the first side of the first portion of the channel. The chamber 250 has a depth greater than the first portion of the channel and the pocket, thereby acting as a valve between the first portion of the channel and the pocket. In some embodiments, the pocket may be shallow, narrow and/or relatively long to keep the leftover fluid inside the pocket even when the disk is subjected to strong acceleration and deceleration. For instance, in some embodiments, the channel or pocket may have a depth up to 1 mm, up to 1.5 mm or up to 2 mm, and the chamber may have a depth that is at least 0.1 mm, at least 0.2 mm, at least 0.3 mm, at least 0.4 mm or at least 0.5 deeper than the channel or pocket. However, the present disclosure is not limited thereto. The channel, chamber and pocket can have other shapes or dimensions and can be positioned differently.

In some embodiments, at least a portion of the structure is positioned radially outwards of the first portion of the channel. For instance, in some embodiments, the pocket 240 or a portion of the porker is positioned radially outwards of the first portion of the channel. In some embodiments, a radially innermost point on a junction formed by the chamber and the first side of the first portion of the channel defines a maximum permissible level (e.g., the dash line in FIG. 2B) for the fluid residue. In some embodiments, the structure and/or operation are designed to ensure that the meniscus of the leftover fluid does not exceed the maximum permissible level. This allows air trapped in the pocket and/or chamber to have an exit passage.

In some embodiments, the second side 222 of the first portion of the channel is positioned radially inwards of the maximum permissible level for the fluid residue. For instance, in some embodiments, the bend at the second side of the first portion is positioned radially inwards of the maximum permissible level. This prevents potential blockage of the channel and allows transferring of the fluid when needed or desired.

During centrifugation, most of the fluid (e.g., blood) will be carried downstream. However, some residues will stick to the channel surfaces. These residues will be pushed to pass the maximum permissible level and collected at the bottom of the first portion 220 of the channel by centrifugal action. As the rotation accelerates, the centrifugal force acting on the remaining blood increases and eventually overcomes the barrier (e.g., the valve formed by the chamber 250 with the channel and/or pocket) after reaching a threshold. The residues will go to the pocket 240, and in some cases to the very bottom of the pocket depending on the rotation speed, the amount of residues, the configuration of the structure, and/or other factors. Afterwards, the residues will remain in the pocket even when the device is subjected to an acceleration, a deceleration, or both.

### Inertia-Based Mixing Chamber and Method

Mixing blood with buffer in centrifugal microfluidics can pose a number of technical problems. For instance, blood cells can be damaged or destroyed when subjected to high centrifugal forces, causing hemolysis (rupture of red blood cells) and the release of hemoglobin into the buffer. This can interfere with downstream analysis and affect the accuracy of the results. Blood can clot when it comes into contact with certain materials or surfaces, especially in microfluidic systems where there is a high surface-to-volume ratio. This can lead to blockages in channels or cause incomplete mixing of blood with the buffer. In addition, achieving complete and uniform mixing of blood with buffer can be challenging in centrifugal microfluidics due to the small volumes and rapid rotation speeds involved. Incomplete mixing can result in inaccurate or unreliable results.

Existing techniques for blood with buffer include those disclosed in “Batch-mode mixing on centrifugal microfluidic platforms,” Lab Chip, 5, 560-565 (2005), “Reciprocating flow-based centrifugal microfluidics mixer disclosed in Review of Scientific Instruments,” 80, 075102 (2009), and “Decanting and mixing of supernatant human blood plasma on centrifugal microfluidic platform,” Microsyst Technol 22, 861-869 (2016), the content of each is incorporated herein by reference in their entirety and for all purposes. These existing techniques, however, do not provide satisfactory solutions. The present disclosure addresses these and other needs in the art by providing chambers with curvatures and using inertia motion to create vortices to promote mixing.

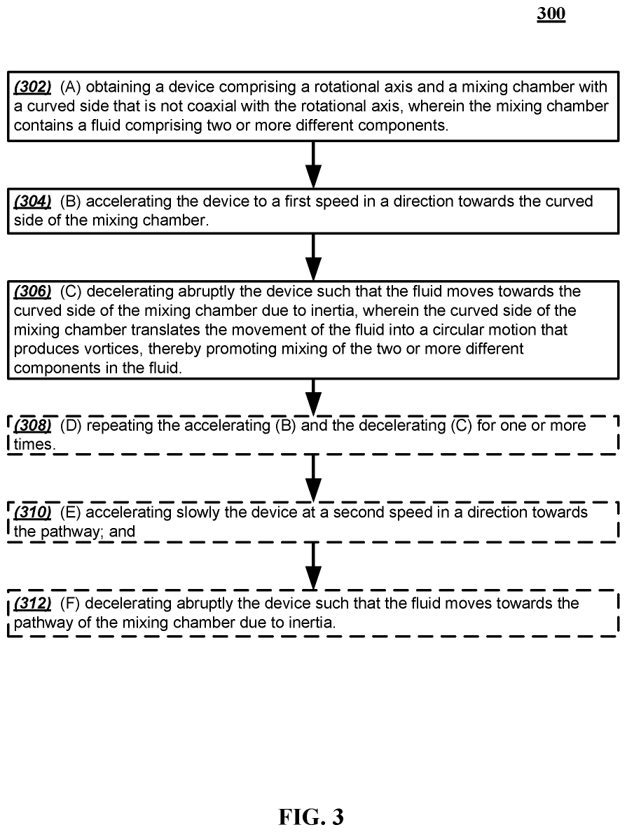

Referring to FIG. 3, there is shown a flowchart illustrating an exemplary method 300 for mixing a fluid in accordance with some embodiments of the present disclosure. In the flowchart, the preferred parts of the method are shown in solid line boxes, whereas additional, optional, or alternative parts of the method are shown in dashed line boxes. It should be noted that the processes disclosed herein and exemplified in the flowchart can be, but do not have to be, executed in full or in the order as they are presented.

Referring to block 302, in some embodiments, the method 300 includes (A) obtaining a device including a rotational axis and a mixing chamber with a curved side that is not coaxial with the rotational axis. The mixing chamber be configured with any suitable shapes and/or sizes and at any suitable positions on the device (e.g., the disk or cartridge) as long as there is a curved side that is not coaxial with the rotational axis. The device can be used for any suitable applications including but not limited to mixing blood with buffer.

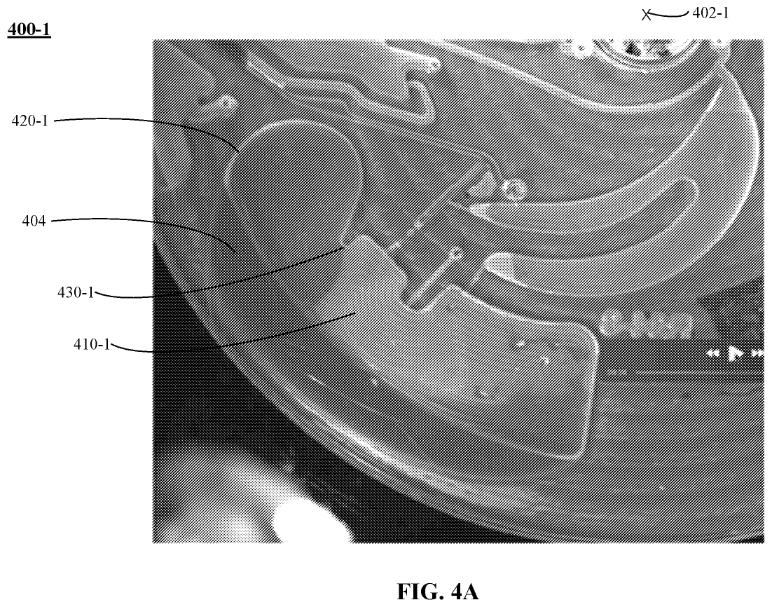

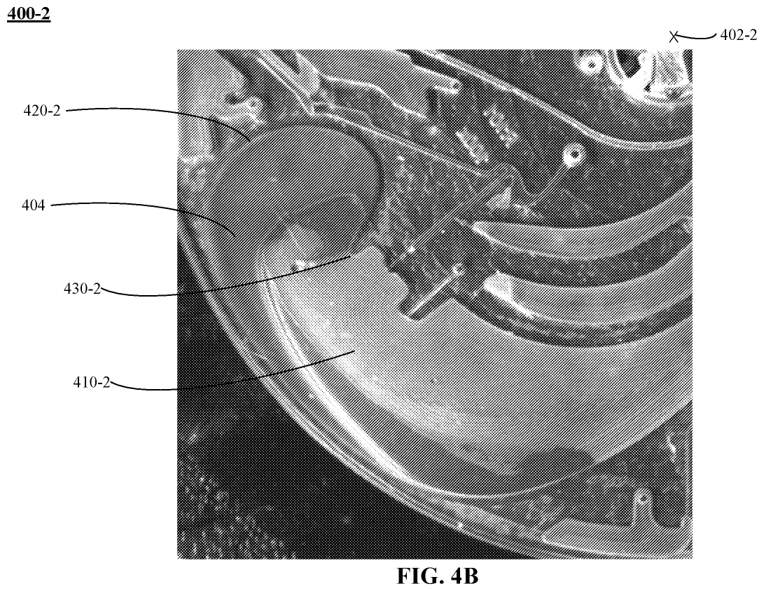

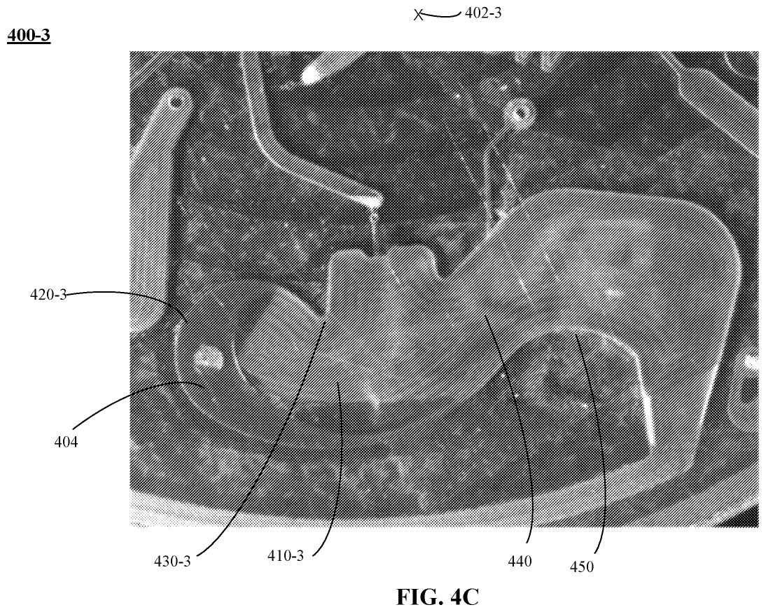

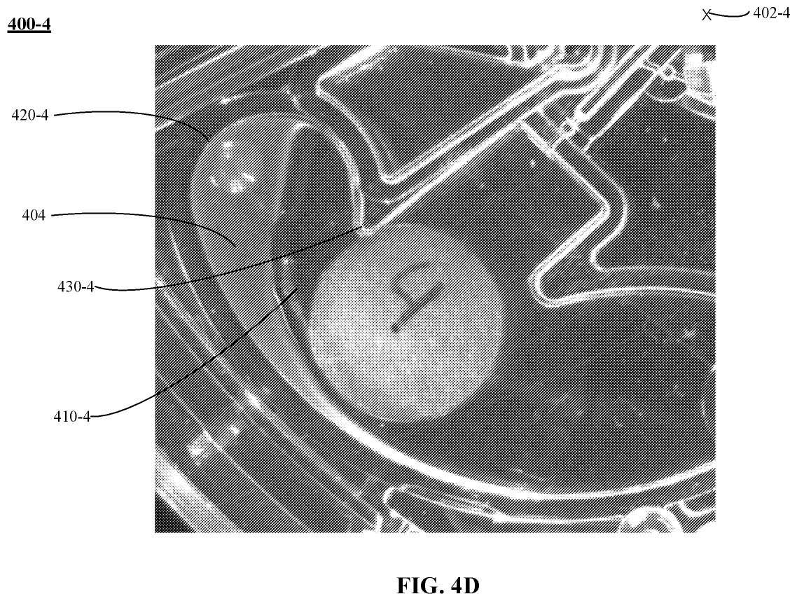

For instance, as a non-limiting example, FIG. 4A illustrates a device 400-1 that is rotatable around a rotational axis 402-1 and includes a chamber 410-1. The chamber 410-1 has a curved side 420-1 that is not coaxial with the rotational axis 402-1. As another non-limiting example, FIG. 4B illustrates a device 400-2 that is rotatable around a rotational axis 402-2 and includes a chamber 410-2. The chamber 410-2 has a curved side 420-2 that is not coaxial with the rotational axis 402-2. As a further non-limiting example, FIG. 4C illustrates a device 400-3 that is rotatable around a rotational axis 402-3 and includes a chamber 410-3. The chamber 410-3 has a curved side 420-3 that is not coaxial with the rotational axis 402-3. As still a further non-limiting example, FIG. 4D illustrates a device 400-4 that is rotatable around a rotational axis 402-4 and includes a chamber 410-4. The chamber 410-4 has a curved side 420-4 that is not coaxial with the rotational axis 402-4.

The mixing chamber contains a fluid 404 including two or more different components. In some embodiments, the volume of the fluid is at most 50%, at most 55%, at most 60%, at most 65% or at most 70% of the mixing chamber. However, the present disclosure is not limited thereto. For instance, in some embodiments, the volume of the fluid may be more than 70% of the mixing chamber. In some embodiments, the fluid may have a volume that is at least 200 μL, at least 400 μL, at least 600 μL, at least 800 μL, or at least 1000 μL. In some embodiments, the fluid may have a volume that is at most 200 μL, at most 150 μL, at most 100 μL, at most 90 μL, at most 80 μL, at most 70 μL, or at most 60 μL, at most 50 μL.

In some embodiments, the mixing chamber has an inflection point or inflection portion, such as the inflection point/portion 430-1, 430-2, 430-3 and 430-4, at which the curvature of the mixing chamber changes sign. In some embodiments, the inflection point/portion is configured to prevent the fluid from flowing to an entrance of the mixing chamber. In some embodiments, the curved side of the mixing chamber has a circular size of about 1 mm to about 10 mm, about 10 mm to about 20 mm, about 20 mm to about 30 mm, or greater.

Referring to block 304, in some embodiments, the method 300 includes (B) accelerating the device to a first speed in a direction towards the curved side of the mixing chamber. The first speed may be based at least in part the type of the fluid, the amount of the fluid in the mixing chamber, the shape of the mixing chamber, or any combination thereof. For instance, in some specific implementations, the first speed may be about 300 rpm to about 500 rpm, about 500 rpm to 700 rpm or about 700 rpm to about 1000 rpm. However, the present disclosure is not limited thereto. For instance, in some specific implementations, the first speed may be lower than 300 rpm or higher than 1000 rpm.

Referring to block 306, in some embodiments, the method 300 includes (C) decelerating abruptly the device such that the fluid moves towards the curved side of the mixing chamber due to inertia. As the fluid moves towards it, the curved side of the mixing chamber translates the movement of the fluid into a circular motion that produces vortices, thereby promoting mixing of the two or more different components in the fluid. In some embodiments, the decelerating (C) brings the device to a full stop. In some embodiments, the decelerating (C) is performed at a deceleration of at least 500 rpm/s, at least 1000 rpm/s, at least 1500 rpm/s, at least 2000 rpm/s, or at least 2500 rpm/s, at least 3000 rpm/s, at least 5000 rpm/s, 10000 rpm/s, at least 50000 rpm/s, or greater. However, the present disclosure is not limited thereto. For instance, in some embodiments, the decelerating (C) may be performed at a deceleration of less than 500 rpm/s.

Referring to block 308, in some embodiments, the method 300 includes (D) repeating the accelerating (B) and the decelerating (C) for one or more times. The method can repeat the accelerating (B) and the decelerating (C) any suitable number of times to produce sufficient mixing. In some embodiments, the method may repeat the accelerating (B) and the decelerating (C) at least 2 times, at least 5 time, at least 10 times, at least 15 times, at least 20 times, at least 30 times, at least 40 times, or at least 50 times.

The method of the present disclosure uses the curvature of the mixing chamber and inertia motion to create vortices. This vortex motion generates shear forces, which can induce mixing of the fluids. This method is based on the principle that components with different densities or viscosities or particulates in the fluid will respond differently to the same inertia force, leading to relative motion between them and ultimately resulting in mixing. The device and method of the present disclosure can reduce hemolysis and clotting and improve mixing efficiency. It is simple in design and does not require new features to be designed/added or the use of different disk materials/surface coatings.

### Inertia-Based Device and Method for Directing Fluid

Many factors play a role in moving or directing fluid in microfluidics. In microfluidic channels, capillary forces can dominate over centrifugal forces, which can lead to non-uniform flow patterns or flow stalling. This can result in incomplete delivery, uneven distribution of samples, and blockages in the channels. At high rotation speeds, the viscosity of the fluid can also affect the flow behavior, leading to the formation of secondary flows and vortices that can interfere with the desired flow patterns. In addition, certain types of ingredients such as detergents dissolved in buffers alter the surface tension or other parameters and thus are prone to bubble formation. It may not be compatible with some centrifugal microfluidic systems and can limit the types of tests that can be performed using this technology.

To address these challenges, various techniques have been developed, such as optimizing the channel design and surface coatings to control capillary forces, selecting appropriate fluids with suitable viscosities and surface tensions. In addition, advanced and expensive microfluidic systems with active feedback and control mechanisms can be used to regulate flow patterns and ensure accurate results. Examples of such techniques or studies include those disclosed in “Frequency-dependent transversal flow control in centrifugal microfluidics,” Lab Chip, 2005, 5, 146-150, “The Effect of Moment of Inertia on the Liquids in Centrifugal Microfluidics,” Micromachines 2016, 7(12), 215, and “Demonstration of an efficient, compact and precise pumping method by centrifugal inertia for lab on disk platforms,” 2019 J. Micromech. Microeng. 29 075001, the content of each is incorporated herein by reference in their entirety and for all purposes. They require complex systems to move or direct the fluid.

The present disclosure addresses these and other needs in the art by developing a technique for directing the flow of liquid in centrifugal microfluidics using the inertia force of the liquid upon sudden deceleration and stopping the disk rotation. This technique involves a chamber and an adjacent chamber, with a wide channel connecting the two, to transfer the liquid from one chamber to the other. When the disk experiences a rapid reduction in rotational velocity, the liquid responds by continuing to move in the direction tangent to the rotational velocity vector of the disk. By carefully designing the size of the wide channel and accounting for factors such as air displacement and surface tension forces, it is possible to direct the liquid to the destination chamber without the need for an external power source or additional complexity to the system.

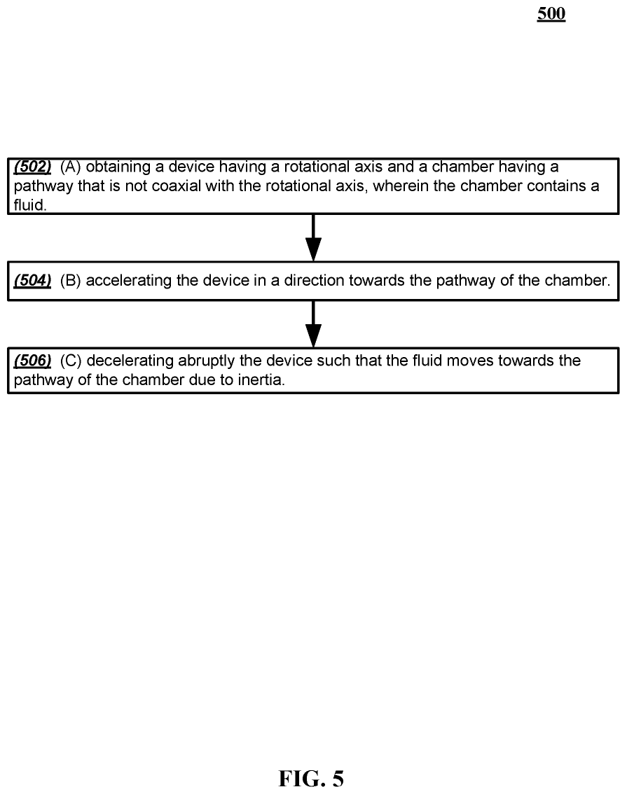

Referring to FIG. 5, there is shown a flowchart illustrating an exemplary method 500 for directing a fluid in accordance with some embodiments of the present disclosure. In the flowchart, the preferred parts of the method are shown in solid line boxes, whereas additional, optional, or alternative parts of the method are shown in dashed line boxes. It should be noted that the processes disclosed herein and exemplified in the flowchart can be, but do not have to be, executed in full or in the order as they are presented.

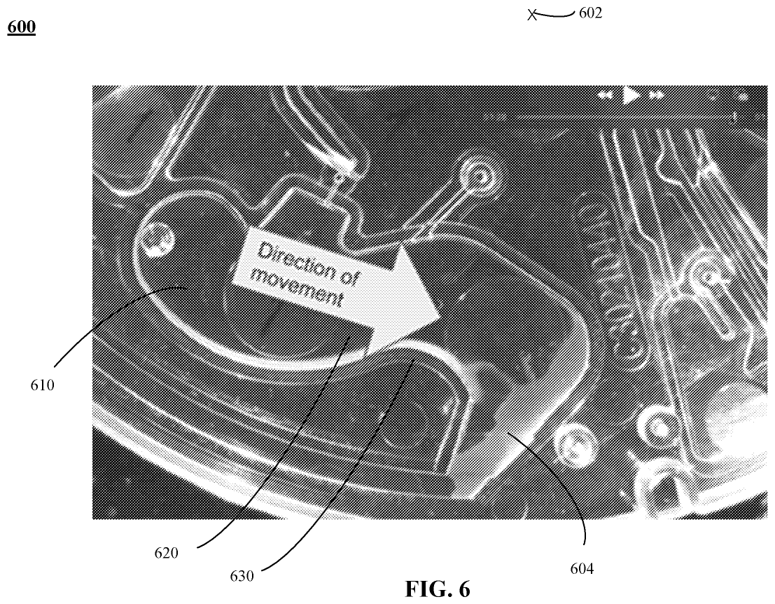

Referring to block 502, in some embodiments, the method 500 includes (A) obtaining a device having a rotational axis and a chamber having a pathway that is not coaxial with the rotational axis, wherein the chamber contains a fluid. For instance, as a non-limiting example, FIG. 6 illustrates a device 600 that is rotatable around a rotational axis 602 and includes a chamber 610. The chamber 610 includes a pathway 620, e.g., a channel that connects the chamber 610 to a downstream chamber. The chamber 610 contains a fluid 604. In some embodiments, the chamber 610 includes a barrier 630 that the fluid has to pass to get into the downstream chamber.

Referring to block 504 and block 506, in some embodiments, the method 500 includes (B) accelerating the device in a direction towards the pathway of the chamber and (C) decelerating abruptly the device such that the fluid moves towards the pathway of the chamber due to inertia. In some embodiments, the accelerating (B) may bring the speed to at least about 200 rpm, at least about 400 rpm, at least about 600 rpm, at least about 800 rpm, or at least about 1000 rpm. In some embodiments, the decelerating (C) is performed at a deceleration of at least 500 rpm/s, at least 1000 rpm/s, at least 1500 rpm/s, at least 2000 rpm/s, or at least 2500 rpm/s, at least 3000 rpm/s, at least 5000 rpm/s, 10000 rpm/s, at least 50000 rpm/s, or greater. In some embodiments, the decelerating (C) brings the device to a full stop. FIG. 6 shows that a considerable volume of fluid is transferred to the downstream chamber.

While FIG. 6 illustrates the chamber 610 being a mixing chamber, it should be noted that this is by way of example and it is non-limiting. The method 500 and the technique can be applied to any other type of chambers. Moreover, the shapes, sizes and positions of the chamber 610 and the pathway 620 can be readily modified to suit other applications. In some embodiments, the pathway is configured to be wide enough to allow easy movement of the fluid.

In embodiments where the chamber 610 is a mixing chamber, the method 500 can be used to direct the fluid after the mixing of the fluid. The mixing of the fluid may be performed using the method 300 or by any other mixing techniques (e.g., using magnetic particles). For instance, referring back to FIG. 3 and FIG. 4C, in some embodiments, the mixing chamber 410-3 includes a pathway 440 (e.g., a channel) opposite to the curved side 420-3 of the mixing chamber. The pathway 440 connects the mixing chamber 410-3 to a downstream chamber. In some embodiments, the mixing chamber 410-3 also includes a barrier 450 that the fluid has to pass to get into the downstream chamber. In some such embodiments, the method 300 may include (E) accelerating slowly the device at a second speed in a direction towards the pathway, and (F) decelerating abruptly the device such that the fluid moves towards the pathway of the mixing chamber due to inertia.

Using inertia to direct flows has potential applications in various microfluidic processes, such as sample preparation and analysis, drug delivery, and microscale synthesis. There is no need for special surface coatings to control capillary forces, no need for advanced and expensive microfluidic systems with active feedback and control mechanisms to regulate flow patterns and ensure accurate results, and no need to select appropriate fluids with suitable viscosities and surface tensions. Parameters such as the curvature of the chamber, the height of the barrier, the length, width and/or depth of the pathway may be optimized to ensure reliable and reproducible results.

### Channel Capable Of Bubble-Free Priming

In microfluidics, it is difficult to removing all the air bubbles from the capillary before filling it with a sample. The presence of air bubbles can cause errors in the sedimentation analysis because it may alter the sedimentation rate of the particles or interfere with the optical detection of the sedimentation process. One approach to achieving bubble-free priming is to use a vacuum or pressure system to evacuate the air from the capillary before filling it with the sample. However, this technique can be challenging to implement, particularly for small diameter capillaries or samples with low sedimentation rates. Another approach is to use a surfactant or wetting agent to help displace the air and wet the inner surface of the capillary. However, the choice of surfactant and its concentration can affect the sedimentation rate, the morphology and integrity of gentle biological objects such as blood cells and thus introduce additional sources of error. Use of stepwise channel has been proposed in “Single-step centrifugal hematocrit determination on a 10-$ processing device,” Biomed Microdevices (2007) 9:795-799, the content of which is incorporated herein by reference in their entirety and for all purposes. However, it uses hydrophilic surface treatment and relies on the capillary forces needed to prime the channel. Overall, achieving bubble-free priming of a dead-end sedimentation capillary requires careful attention to the choice of material, method, equipment, and sample preparation, as well as optimization of the experimental conditions to ensure accurate and reproducible sedimentation analysis.

The present disclosure addresses these and other needs in the art by providing a capillary channel where the priming with the liquid is based on the differentiation of the flow resistances propagating along different lanes of the channel. As such, the capillary channel of the present disclosure can be made of any non-treated material, including hydrophilic and hydrophobic, while still achieving bubble-free priming.

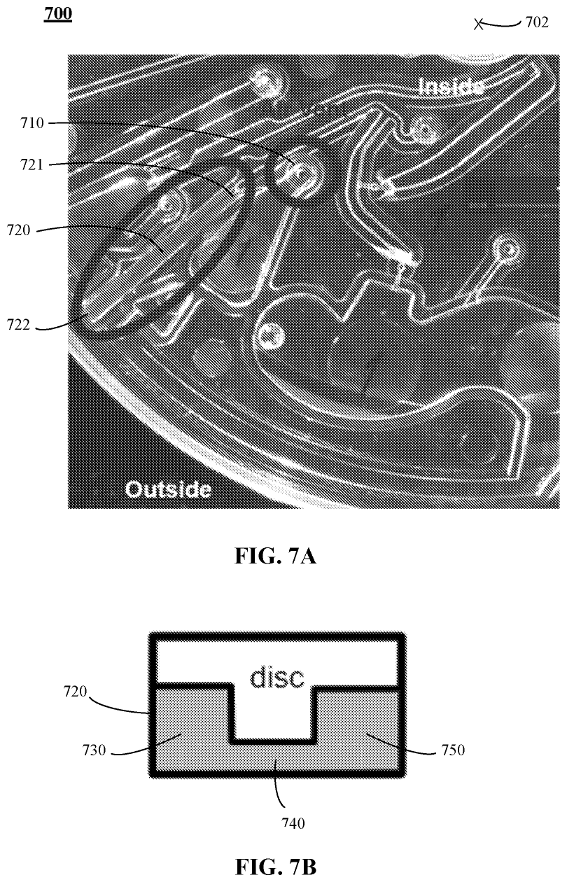

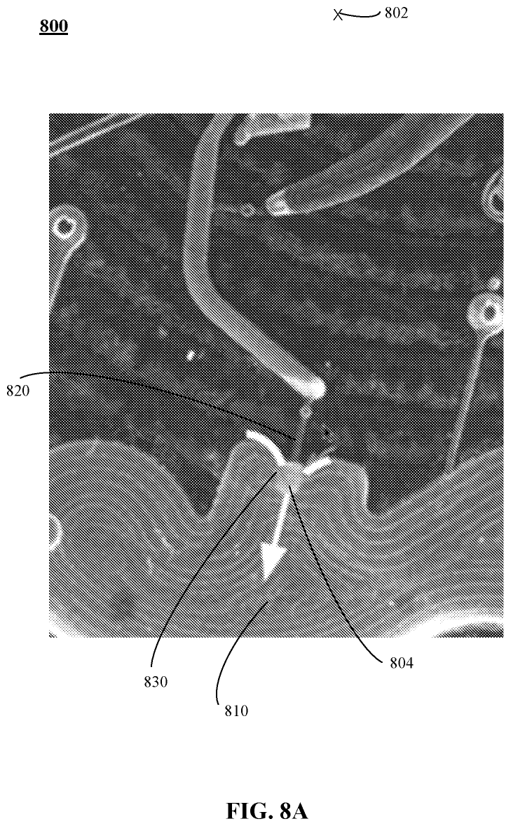

Referring to FIGS. 7A and 7B, there is shown a device 700 in accordance with some embodiments of the present disclosure. The device 700 is rotatable around a rotational axis 702. The device 700 includes a vent port 710 and a capillary channel 720 positioned radially outwards of the vent port with respect to the rotational axis 702.

The capillary channel 720 is configured to have a stepwise shaped cross-section to facilitate the bubble-free priming. It is designed to transport fluid (e.g., blood) from the inlet into the blind capillary using differentiation of fluid resistances driven by centrifugation. The distinct depth profile of the capillary reliably prevents the trapping of air during the filling process.

The capillary channel 720 includes an open end 721 and a dead end 722 positioned radially outwards of the open end with respect to the rotational axis. The capillary channel can be oriented along the radius or at an angle to it. The angle can vary. In some embodiments, the angle may be in the range of 0-60 degrees. The capillary channel 720 also includes a first lane 730, a second lane 740 and a third lane 750. The first lane has an inlet at the open end for receiving a fluid. The third lane has an outlet at the open end for venting air. For instance, in some embodiments, the outlet of the third lane of the capillary channel is connected to the vent port. The second lane is formed between the first and third lanes and connected to the first and third lanes. The first, second and third lanes are configured such that the second lane has a flow resistance different than the first and third lanes, thereby allowing the fluid to flow first through the first lane 730 from the open end 721 to the dead end 722 and then flow through the second lane 740, the third lane 750 or both from the dead end 722 to the open end 721 to facilitate bubble-free priming.

In some embodiments, the first, second and third lanes collectively form a stepwise cross-section perpendicular to a length direction of the capillary channel as illustrated in FIG. 7B. In some embodiments, the first and third lanes are deeper than the second lane, e.g., the shallow second lane separating the deeper first and third lanes. The bordering extension acts as a barrier, creating a fluidic separation of the two levels at the adjacent edge. The filling of the dead-end channel is promoted at one level where the fluid is exposed to a lower resistance, while air is removed through the higher resistance level as the fluid progresses downstream. As the fluid reaches the dead end of the capillary, it penetrates to the adjacent level to fill the capillary in the reverse direction without trapping air bubbles.

The third lane has access to the vent and is added for additional reliability to extend the range of application, especially if the fluid (e.g., blood) crosses the edge separating the 1st and the 2nd lanes before reaching the dead end. This can happen if there are defects on the wall or the resistance difference is insufficient for a clear separation of flows. This process ensures that the capillary is filled without any air bubbles. The number of lanes does not have to three. For instance, the number of lanes may be two, or may be more than three, with the last one has access to the vent.

The first and third lanes may be configured substantially the same as each other (e.g., have the same width and depth) or differently from each other (e.g., have different widths and/or different depths). In some embodiments, at least two of the first, second and third lanes have a same width. In some embodiments, at least two of the first, second and third lanes have a different width. In some specific implementations, the first and third lanes may have a depth of about 500 μm to 1000 μm, about 1000 μm to 1500 μm, or about 1500 μm to 2000 μm. The second lane may be about 200 μm to about 500 μm, about 300 μm to about 700 μm, or about 600 μm to 1000 μm shallower than the first and/or third lane. The radial length of the capillary channel may be at least 5 mm, at least 10 mm, at least 15 mm, at least 20 mm, at least 25 mm, or at least 30 mm. The width of each lane may be chosen so that the flow resistance is different between the shallow and the deep lanes. In some embodiments, the width of the first, second and/or third lane may be in the range of about 100 μm to about 500 μm, about 300 μm to about 700 μm, or about 500 μm to 1000 μm. However, the present disclosure is not limited thereto. Depending on the applications, the channel, including the first, second and third lanes, can have any other suitable shapes and sizes.

The capillary channel of the present disclosure does not need a vacuum or pressure system to evacuate the air from the capillary before filling it with a sample, or surfactant or wetting agent to help displace the air and wet the inner surface of the capillary. It is simple and can be used for various applications.

### Pinched Structure For Directing Fluid

Surface tension is a critical factor in microfluidics, where the behavior of liquids can be significantly different from their bulk counterparts due to the small scales involved. The interaction between the liquid and the channel walls can lead to various phenomena, including capillary flow, where the liquid follows the shape of the channel edge rather than the direction of the applied force. In some cases, this can be undesirable and needs to be eliminated. For instance, surface tension can influence the direction in which a liquid follows after exiting a channel expansion in a microfluidic, creating a meniscus or curved surface at the interface between liquid and air. The shape and strength of the meniscus depend on the properties of the fluid, such as its surface tension, as well as the shape and surface properties of the channel. If the surface tension of the liquid is high and the channel extension shape has an edge with the corners that promote wetting, then the liquid will tend to spread and follow the direction along the edge instead of centrifugal force. This is known as capillary flow.

When fluid leaves a small microfluidic channel and enters a larger chamber, a surface interaction problem can arise. The surface properties of the larger chamber at the junction can influence the behavior of the flow, directing it in an uncontrolled direction. For example, if the surface has non-uniform physical and chemical properties, the liquid may not leave the fitting in the direction of the centrifugal force, but instead follow the angle of the fitting, which may affect the operation of the system.

These technical problems can be mitigated through the use of surface treatment or adding surfactants. However, they add more cost to manufacture, can potentially cause cell damages and are complex. The present disclosure addresses these and/or other issues in the art by providing an extension so that the centrifugal force will act in the opposite direction to the capillary force vector, and thus compensate for it.

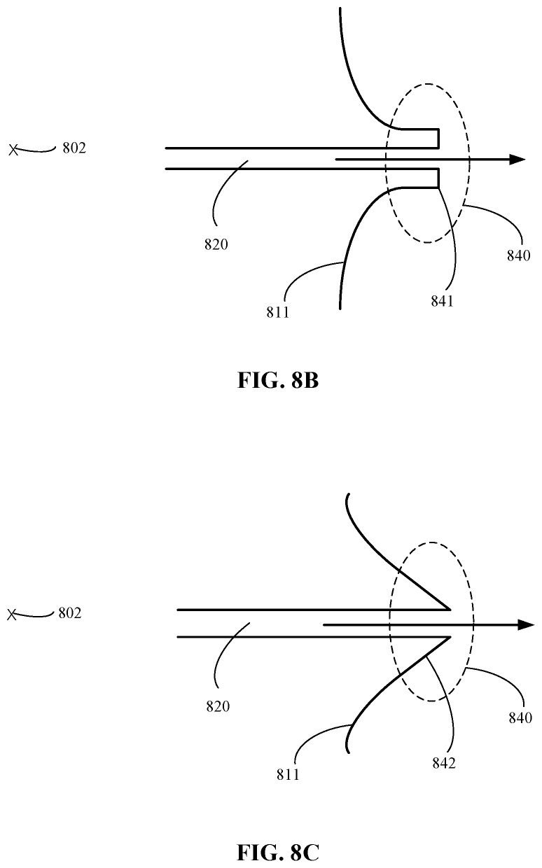

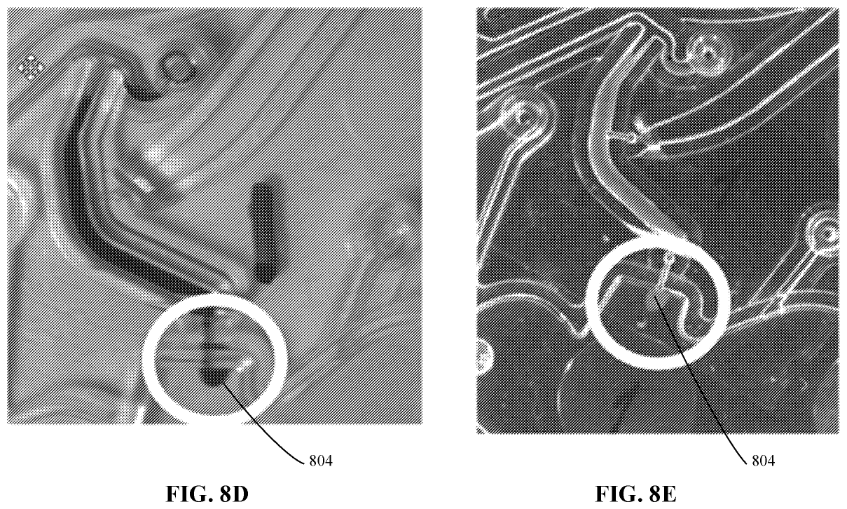

Referring to FIGS. 8A-8C, there is shown a device 800 in accordance with some embodiments of the present disclosure. The device 800 is rotatable around a rotational axis 802. The device 800 includes a chamber 810 and a channel 820 connected to the chamber for delivering a fluid 804 to the chamber. The chamber and channel collectively form a junction 830 that minimizes or eliminates capillary flow when the fluid exits from the channel (e.g., an outlet of the channel) into the chamber. In some embodiments, the junction allows the fluid to flow from the outlet of the channel into the chamber in a direction of the centrifugal force.

In some embodiments, the channel includes a protruding portion 840 that forms at least a portion of the junction. The protruding portion 840 is configured such that the fluid is pinched at the protruding part for a while until the centrifugal force exceeds the surface tension forces holding the fluid. During this holding moment, there is no movement of the fluid to the left or right, as would be the case for straight-lined edges shown in FIGS. 8D and 8E where the flat walls allow the fluid (e.g., blood) 804 to flow unpredictably. As soon as the centrifugal force overcomes the surface tension, the interaction of the fluid with the surface is broken, and the fluid will move in the direction of the centrifugal force. In this way, the direction of fluid flow can be predicted.

The protrusion portion can be configured with any suitable shapes and sizes. As a non-limiting example, FIG. 8B illustrates that the protruding portion includes a U-shaped wall 841 on each side of the channel at the outlet of the channel. As another non-limiting example, FIG. 8C illustrates that the protruding portion includes a V-shaped wall 842 on each side of the channel at the outlet of the channel. In some embodiments, the wall 811 of the chamber 810 adjacent to the outlet of the channel is curved radially inward relative to the outlet of the channel to form at least a portion of the junction. By applying a centrifugal force that exceeds the surface tension forces, the fluid can be forced to move in a desired direction. This is achieved by pinching the fluid at the channel extension, creating a moment of balance between the forces, and then releasing it when the centrifugal force becomes dominant.

In some specific implementations, the channel may have a width of about 100 μm to about 200 μm, about 200 μm to about 300 μm, about 300 μm to about 400 μm, or about 400 μm to about 500 μm, and/or may have a depth of about 100 μm to about 200 μm, about 200 μm to about 300 μm, about 300 μm to about 400 μm, or about 400 μm to about 500 μm. In some embodiments, the curvature radii of the U-shaped walls may be about 100 μm to about 200 μm, about 200 μm to about 300 μm, about 300 μm to about 400 μm, or about 400 μm to about 500 μm. However, the present disclosure is not limited thereto. Depending on the applications, the channel and protruding portion can be configured with various shapes and sizes.

The pinched structure of the present disclosure negates the use of surface treatment that would add more cost to manufacture and potentially cause cell damages. The pinched structure of the present disclosure also negates the need to add surfactants that would be complex and potentially cause cell damages.

Device and Method for Measuring Depths with Self-Calibration Capability

There can be various causes of manufacturing variabilities of the depth of molded consumables. Some of them are inconsistent molding conditions where the depth of molded consumables can be affected by inappropriate control of temperature, pressure, cooling rate, humidity etc. To account for these variabilities of depths of molded consumables, an appropriate measurement technique has to be used. Examples of the techniques include profilometers, depth gauges, laser scanners, optical interferometry, and ultrasonic sensors. However, to measure every consumable depth during its assembly is a labor and time-consuming procedure. In addition, a consumable may change the depth as it ages.

The uneven depth of some consumable compartments may cause unstable operation. For example, if the depth of the molded metering chamber in a microfluidic consumable is changed, this may result in a mismatch in the volume of dispensed liquid, which may lead to incorrect test results. Microfluidic consumables are used for precise measurements and handling of small amounts of fluids in applications such as medical diagnostics, drug discovery, and genetic analysis. Inaccurate metering due to the variations in the depth of molded metering chambers can result in incorrect measurements, leading to false-positive or false-negative results, which can have serious consequences in critical applications. Therefore, it is important that the depth of molded compartments in microfluidic consumables is accurately measured to ensure correct and reliable test results.

The present disclosure addresses these and/or other issues in the art by implementing self-calibration features that can be used to measure production deviations in the depth of devices (e.g., molded consumables) directly at the user's site and/or as part of an analysis method. The measurement is fast (e.g., in a matter of seconds) and without any labor involvement.

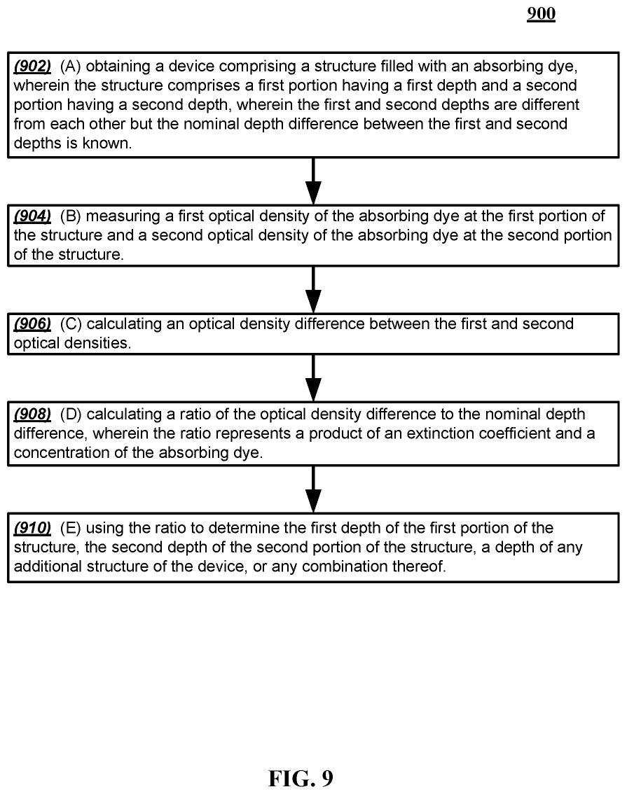

Referring to FIG. 9, there is shown a flowchart illustrating an exemplary method 900 for measuring depths despite of manufacturing variabilities in accordance with some embodiments of the present disclosure. In the flowchart, the preferred parts of the method are shown in solid line boxes, whereas additional, optional, or alternative parts of the method are shown in dashed line boxes. It should be noted that the processes disclosed herein and exemplified in the flowchart can be, but do not have to be, executed in full or in the order as they are presented.

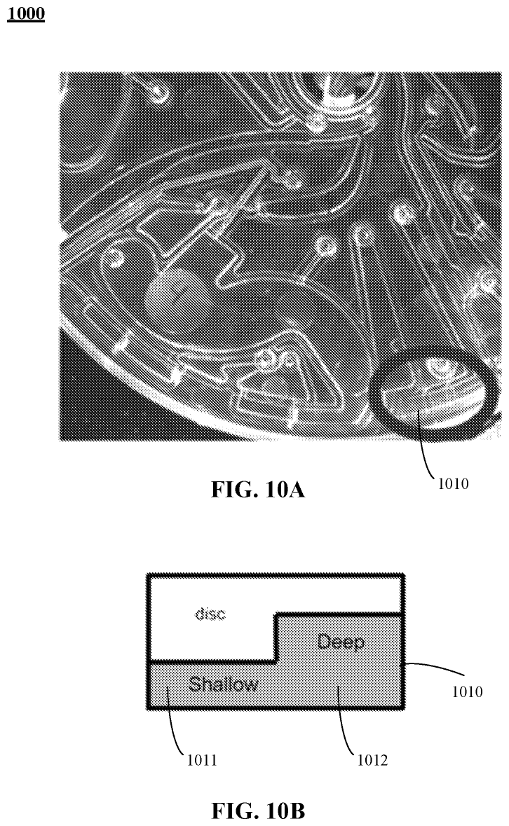

Referring to block 902, in some embodiments, the method 900 includes (A) obtaining a device including a structure filled with an absorbing dye, wherein the structure includes a first portion having a first depth and a second portion having a second depth, wherein the first and second depths are different from each other but the nominal depth difference between the first and second depths is known. For instance, as a non-limiting example, FIGS. 10A and 10B illustrates a device 1000 including a structure 1010. The structure 1010 includes a first portion 1011 and a second portion 1012. The first portion 1011 has a first depth L and the second portion 1012 has the second depth L2. The first and second depths are different from each other. These depths are not necessarily equal to their nominal values as they are subject to manufacturing variations. However, the difference between these depths may correspond to the nominal depth difference because in many cases production variability has a similar effect on variance. In other words, while the first and second depths might not be their nominal values, the nominal depth difference (delta L) between the first and second depths is known. In some embodiments, once the device is obtained, an absorbing dye is filled into the structure.

Referring to block 904, in some embodiments, the method 900 includes (B) measuring a first optical density (OD₁) of the absorbing dye at the first portion of the structure and a second optical density (OD₂) of the absorbing dye at the second portion of the structure. In some embodiments, the first and second optical densities are measured using a spectrophotometer or a microfluidics device that measures absorbance.

Referring to block 906, in some embodiments, the method 900 includes (C) calculating an optical density difference (delta OD) between the first and second optical densities.

Referring to block 908, in some embodiments, the method 900 includes (D) calculating a ratio of the optical density difference to the nominal depth difference, wherein the ratio represents a product of an extinction coefficient and a concentration of the absorbing dye. For instance, according to the Beer-Lambert law:

$$O {D}_{1} = e c {L}_{1} \qquad ( 1 )$$

$$O {D}_{2} = e c {L}_{2} \qquad ( 2 )$$

where e is the extinction coefficient of the absorbing dye, c is its concentration, L₁ and L₂ are the depths of the first and second depths. It is not necessary to know the concentrations and extinction coefficient of the dye.

In some embodiments, the ratio is calculated as follows:

$$ec = delta OD / delta L \qquad ( 3 )$$

Referring to block 910, in some embodiments, the method 900 includes (E) using the ratio to determine the first depth of the first portion of the structure, the second depth of the second portion of the structure, a depth of any additional structure of the device, or any combination thereof. For instance, in some embodiments, the obtained ratio (ec) is then plugged back into equation (1) to calculate the first depth L₁ and/or equation (2) to calculate the second depth L₂.

While FIG. 10A illustrates the device with one structure 1010 and FIG. 10B illustrates the structure 1010 with two different depths, it should be noted that the device can have more than 1, more than 2, more than 3, more than 4, more than 5, or more than 10 structures, and a structure can have more than 2, more than 3, more than 4, or more than 5 different portions with different depths. The structures can be positioned at any suitable locations on the device to allow multiple measurements to ensure consistency in depth. The structures can be configured the same as each other or differently from each other. They can also have different pairs of levels for calibrating deep and shallow channels, can be two or more connected in series, or standalone channels.

For instance, in some embodiments, the device 1000 includes one or more structures. Each of the one or more structures includes a first portion having a first depth and a second portion having a second depth. For each of the one or more structures, the first and second depths are different from each other but a nominal depth difference between the first and second depths is known. This allows self-calibration of a depth of any structure (e.g., the one or more structures or other structures) the device independent of variations in manufacturing the device. In some embodiments, the one or more structures includes a first structure and a second structure at different locations of the device. In some such embodiments, the nominal depth difference of the first structure is the same as the second structure. Alternatively, in some embodiments, the nominal depth difference of the first structure is different than the second structure.

### Device And Method For Measuring Concentration Despite Manufacturing Variability

Measuring hemoglobin concentration is a critical test for diagnosing anemia, monitoring blood loss, and assessing overall health. The use of microfluidics technology has made it possible to perform this test with a small sample size and in a short amount of time. However, there can be manufacturing variability in microfluidics consumable, which can affect the accuracy of the test results. There can be various causes of manufacturing variabilities of the depth of molded consumables. Some of them are inconsistent molding conditions where the depth of molded consumables can be affected by inappropriate control of temperature, pressure, cooling rate, humidity and/or other factors.

One way to address this issue is to calibrate the microfluidics device before use. Calibration involves determining the device's sensitivity and accuracy by measuring the hemoglobin concentration of a standard solution. This information can then be used to adjust the test results obtained from the device. However, this calibration relies on the consumable manufacturing consistency. For instance, if the concentration determination is based on the hemoglobin optical density measure, then the optical pathway is a critical parameter. In this regard, the depth of the microfluidic optical compartment has to be accurately determined.

The present disclosure addresses these and/or other issues in the art by providing a device and method to determine the hemoglobin concentration by measuring its optical density without the need for the absolute depth determination. The methodology of this approach is similar to the methodology for measuring manufacturing variabilities.

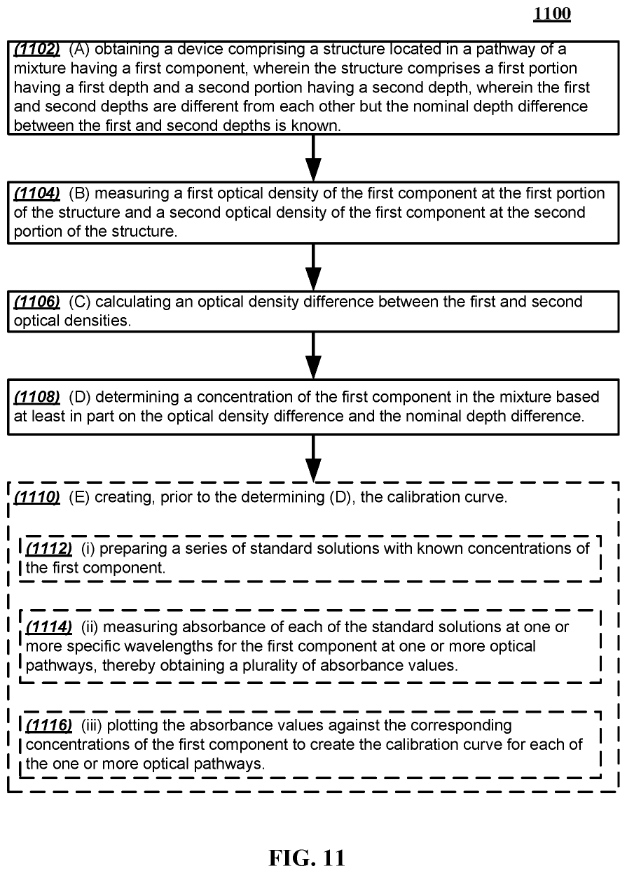

Referring to FIG. 11, there is shown a flowchart illustrating an exemplary method 1100 for measuring concentration despite of manufacturing variability in accordance with some embodiments of the present disclosure. In the flowchart, the preferred parts of the method are shown in solid line boxes, whereas additional, optional, or alternative parts of the method are shown in dashed line boxes. It should be noted that the processes disclosed herein and exemplified in the flowchart can be, but do not have to be, executed in full or in the order as they are presented.

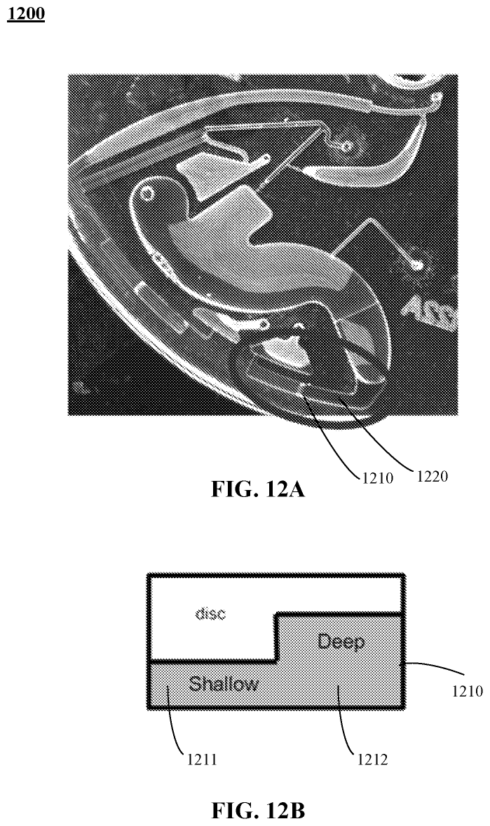

Referring to block 1102, in some embodiments, the method 1100 includes (A) obtaining a device including a structure located in a pathway of a mixture having a first component, wherein the structure includes a first portion having a first depth and a second portion having a second depth, wherein the first and second depths are different from each other but the nominal depth difference between the first and second depths is known. For instance, as a non-limiting example, FIGS. 12A and 12B illustrates a device 1200 including a structure 1210 located in a pathway 1220 of a mixture having a first component (e.g., a mixture containing hemoglobin). The structure 1210 includes a first portion 1211 and a second portion 1212. The first portion 1211 has a first depth L₁ and the second portion 1212 has the second depth L₂. The first and second depths are different from each other. These depths are not necessarily equal to their nominal values as they are subject to manufacturing variations. However, the difference between these depths may correspond to the nominal depth difference because in many cases production variability has a similar effect on variance. In other words, while the first and second depths might not be their nominal values, the nominal depth difference (delta L) between the first and second depths is known.

Referring to block 1104, in some embodiments, the method 1100 includes (B) measuring a first optical density (OD₁) of the first component at the first portion of the structure and a second optical density (OD₂) of the first component at the second portion of the structure. In some embodiments, the first and second optical densities are measured using a spectrophotometer or a microfluidic device that measures absorbance.

Referring to block 1106, in some embodiments, the method 1100 includes (C) calculating an optical density difference (delta OD) between the first and second optical densities.

Referring to block 1108, in some embodiments, the method 1100 includes (D) determining a concentration of the first component in the mixture based at least in part on the optical density difference and the nominal depth difference. For instance, according to equations (1) and (2), delta OD is a function of delta L as follows:

$$delta OD = ec delta L \qquad ( 4 )$$

As such, the optical density difference (delta OD) obtained from the calculating (C) can be compared with a calibration curve that has been built for the same optical pathway as delta L. The calibration curve may be created using a high accuracy depth quartz cuvette. The output signal can thus be used to determine the concentration of the first component (e.g., the hemoglobin concentration) in the mixture. It is not necessary to know the extinction coefficient of the first component (e.g., hemoglobin) as it uses the calibration curve.

In some embodiments, if the extinction coefficient for the first component is known (e.g., the extinction coefficient is determined for the wavelength used in the device optical system), then the calibration curve is not needed. The concentration of the first component can be calculated using equation (4), e.g., by dividing the optical density difference with the nominal depth difference and the extinction coefficient of the first component, because delta OD, delta L and e are known.

Referring to block 1110 to block 1116, in some embodiments, the method 1100 includes (E) creating, prior to the determining (D), the calibration curve. In some embodiments, the creating (E) includes (i) preparing a series of standard solutions with known concentrations of the first component, (ii) measuring absorbance of each of the standard solutions at one or more specific wavelengths for the first component at one or more optical pathways, thereby obtaining a plurality of absorbance values, and (iii) plotting the absorbance values against the corresponding concentrations of the first component to create the calibration curve for each of the one or more optical pathways.

For instance, in some embodiments where the first component is hemoglobin, the method includes preparing a series of standard solutions with known concentrations of hemoglobin, using a spectrophotometer or a microfluidics device to measure the absorbance of each of the standard solutions at a specific wavelength(s) for hemoglobin, plotting the absorbance values against the corresponding hemoglobin concentrations to create a calibration curve. In some embodiments, the method also includes measuring the absorbance of the unknown sample at the same wavelength used to measure the standard solutions, and/or using the calibration curve to determine the hemoglobin concentration of the unknown sample based on its absorbance value.

Like the device 1000, the device 1200 can have more than one structure 1210. Similarly, like the structure 1010, the structure 1210 can have more than two different portions. In addition, a device can have both the structure(s) 1010 and the structure(s) 1210 for performing both the method 1000 and the method 1200.

The device and method of the present invention make the absorbance and thus concentration measurement less dependent on the depth and thus improve measurement accuracy.

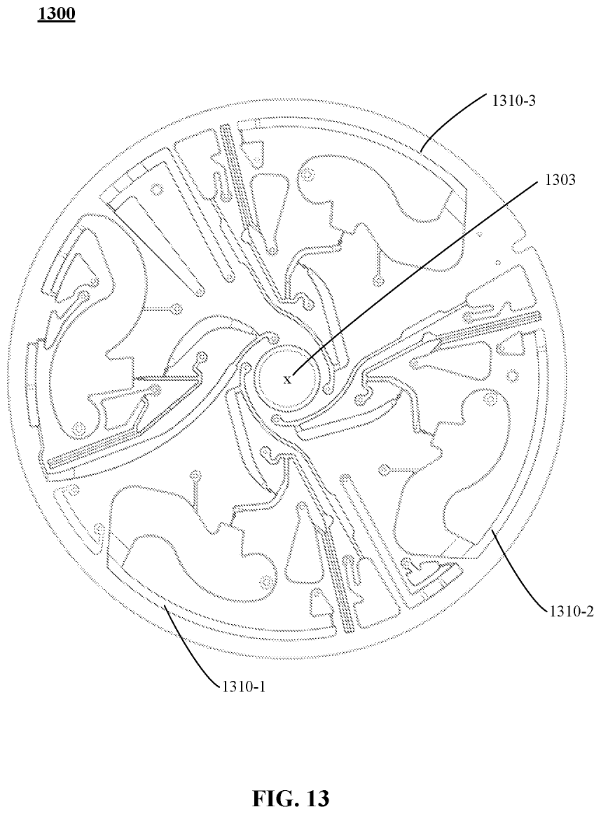

Referring to FIG. 13, there is shown a device 1300 (e.g., a disc) in accordance with some exemplary embodiments of the present disclosure. The device 1300 is rotatable about a rotational axis, such as the vertical rotational axis 1303. In some implementations, the device 1300 may be rotated, during one or more processes, at a speed of at least about 1000 rpm, at least about 1200 rpm, at least about 1400 rpm, at least about 1600 rpm, at least about 1800 rpm, at least about 2000 rpm, at least about 2200 rpm, at least about 2400 rpm, at least about 2600 rpm, at least about 2800 rpm, at least about 2900 rpm, at least about 3000 rpm, at least about 3500 rpm, at least about 4000 rpm, at least about 4500 rpm, at least about 5000 rpm, at least about 5500 rpm, at least about 6000 rpm, at least about 6500 rpm, or at least about 7000 rpm. In some implementations, the device 1300 may be rotated, during one or more processes, at a speed of at most about 500 rpm, at most about 600 rpm, at most about 700 rpm, at most about 800 rpm, at most about 900 rpm, at most about 1000 rpm, at most about 1200 rpm, at most about 1400 rpm, at most about 1600 rpm, at most about 1800 rpm, at most about 2000 rpm, at most about 2200 rpm, at most about 2400 rpm, at most about 2600 rpm, at most about 2800 rpm, at most about 2900 rpm, at most about 3000 rpm, at most about 3500 rpm, at most about 4000 rpm, at most about 4500 rpm, or at most about 5000 rpm.

In some embodiments, the device 1300 (e.g., the disc) includes a plurality of units, such as units 1310-1, 1310-2, 1310-3, arranged circumferentially. In some embodiments, the device 1300 includes 2, 3, 4, 5, 6, 7, 8, 9, 10, or more than 10 units. In some embodiments, a unit 1310 includes one or more features/components/devices (e.g., the device/structure 100, the device/structure 200, the device/structure 400, the device/structure 600, the device/structure 700, the device/structure 800, the device/structure 1000, and/or device/structure 1200) disclosed herein. In some embodiments, each unit 1310 includes one or more features/components/devices disclosed herein. In some embodiments, at least one unit is identical to another unit in the plurality of units. In some embodiments, at least one unit is different than the other unit(s) in the plurality of units.

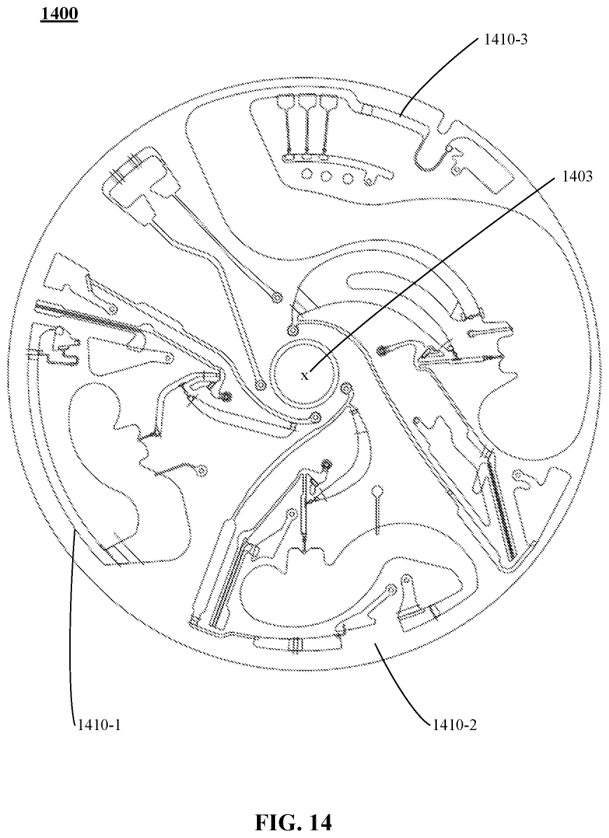

Referring to FIG. 14, there is shown a device 1400 (e.g., a disc) in accordance with some exemplary embodiments of the present disclosure. The device 1400 is rotatable about a rotational axis, such as the vertical rotational axis 1403. In some implementations, the device 1400 may be rotated, during one or more processes, at a speed of at least about 1000 rpm, at least about 1200 rpm, at least about 1400 rpm, at least about 1600 rpm, at least about 1800 rpm, at least about 2000 rpm, at least about 2200 rpm, at least about 2400 rpm, at least about 2600 rpm, at least about 2800 rpm, at least about 2900 rpm, at least about 3000 rpm, at least about 3500 rpm, at least about 4000 rpm, at least about 4500 rpm, at least about 5000 rpm, at least about 5500 rpm, at least about 6000 rpm, at least about 6500 rpm, or at least about 7000 rpm. In some implementations, the device 1400 may be rotated, during one or more processes, at a speed of at most about 500 rpm, at most about 600 rpm, at most about 700 rpm, at most about 800 rpm, at most about 900 rpm, at most about 1000 rpm, at most about 1200 rpm, at most about 1400 rpm, at most about 1600 rpm, at most about 1800 rpm, at most about 2000 rpm, at most about 2200 rpm, at most about 2400 rpm, at most about 2600 rpm, at most about 2800 rpm, at most about 2900 rpm, at most about 3000 rpm, at most about 3500 rpm, at most about 4000 rpm, at most about 4500 rpm, or at most about 5000 rpm.

In some embodiments, the device 1400 (e.g., the disc) includes a plurality of units, such as units 1410-1, 1410-2, 1410-3, arranged circumferentially. In some embodiments, the device 1400 includes 2, 3, 4, 5, 6, 7, 8, 9, 10, or more than 10 units. In some embodiments, a unit 1410 includes one or more features/components/devices (e.g., the device/structure 100, the device/structure 200, the device/structure 400, the device/structure 600, the device/structure 700, the device/structure 800, the device/structure 1000, and/or device/structure 1200) disclosed herein. In some embodiments, each unit 1410 includes one or more features/components/devices disclosed herein. In some embodiments, at least one unit is identical to another unit in the plurality of units. In some embodiments, at least one unit is different than the other unit(s) in the plurality of units.

### Exemplary Workflow(s)

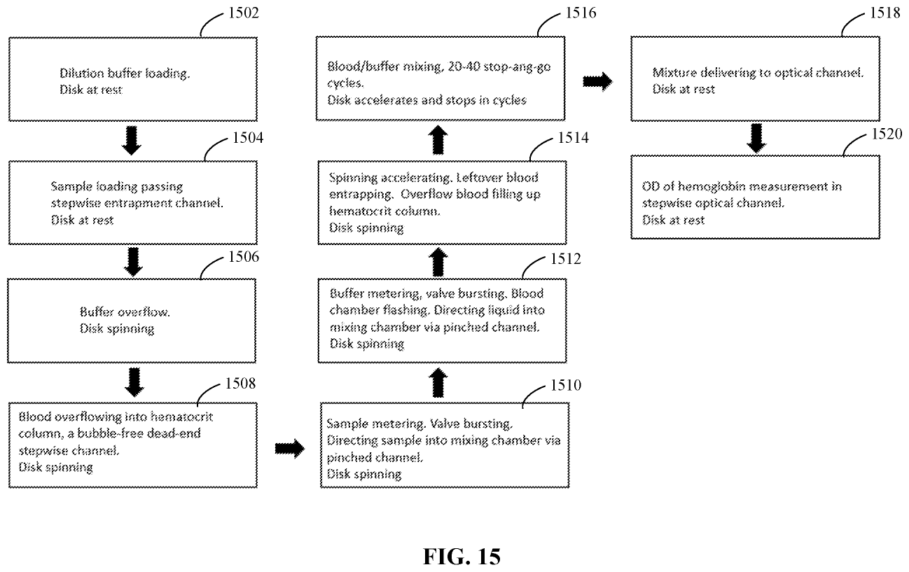

Referring to FIG. 15, there is illustrated an exemplary workflow 1500 in accordance with some exemplary embodiments of the present disclosure. The workflow 1500 can be performed on any suitable devices disclosed herein (e.g., the device 1300 or the device 1400). The workflow 1500 can also be automated. Further, while specific specimens (e.g., whole blood) are used in describing the workflow, it should be noted that the present disclosure is not limited thereto. Other samples, such as those disclosed herein, can be used. In addition, the processes disclosed herein and exemplified in the workflow 1500 can be, but do not have to be, executed in full or in the order as they are presented.

The workflow 1500 may be configured to perform one or more assays, including but not limited to white blood cells (WBC) assay, red blood cells (RBC) assay, and/or hemoglobin (HgB) assay. In some embodiments, the workflow 1500 may be configured to perform a plurality of assays, e.g., any two or all of the WBC assay, RBC assay, and hemoglobin assay. In some embodiments, the workflow 1500 may be configured to perform one or more additional or optional processes, such as a self-calibration process.

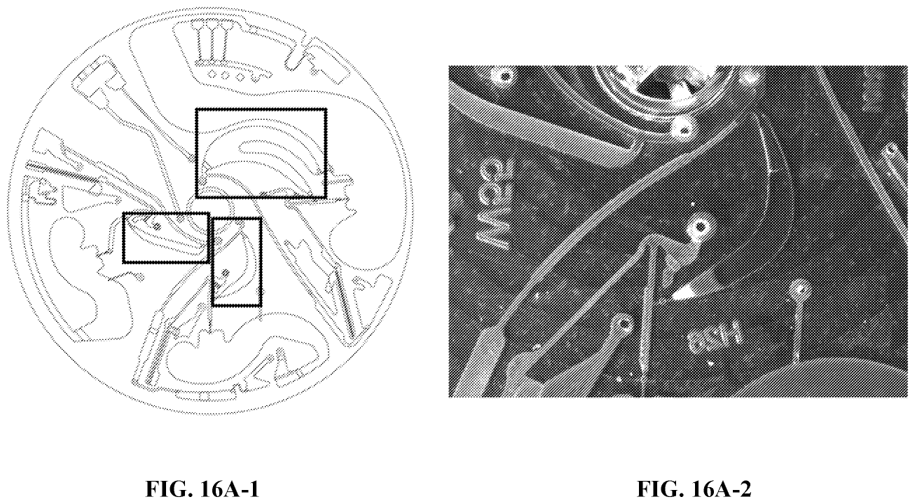

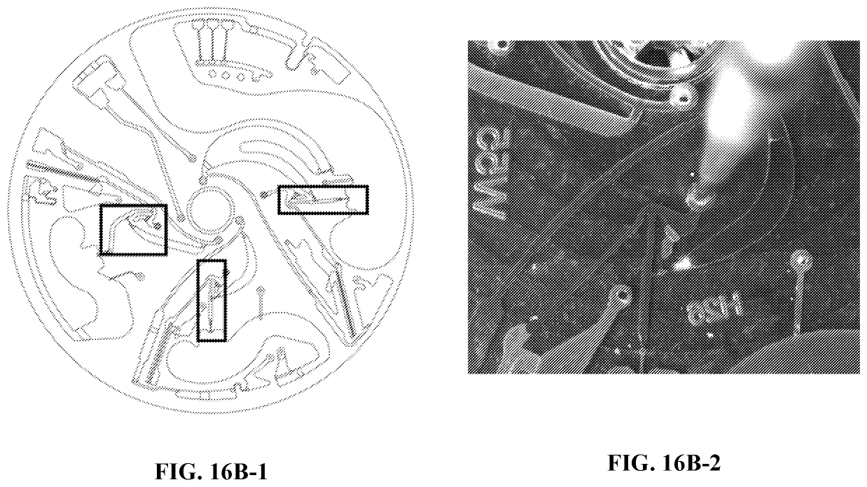

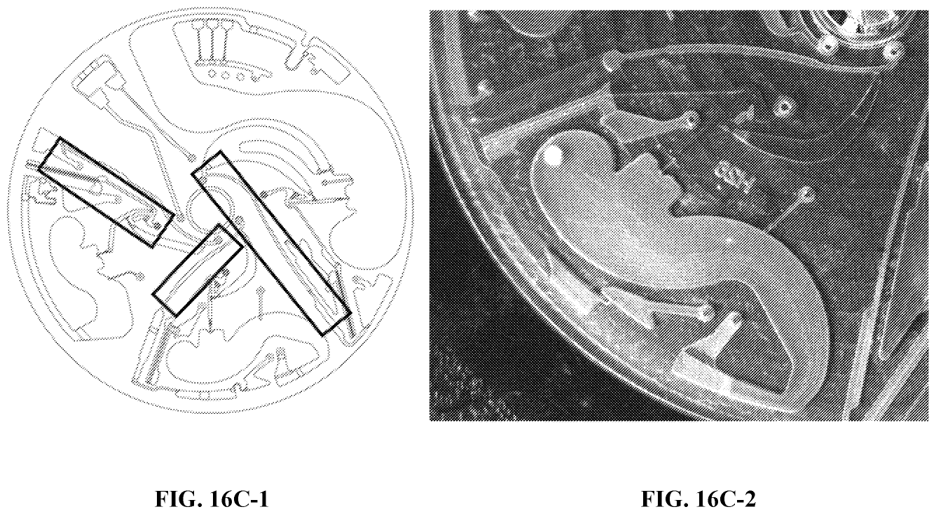

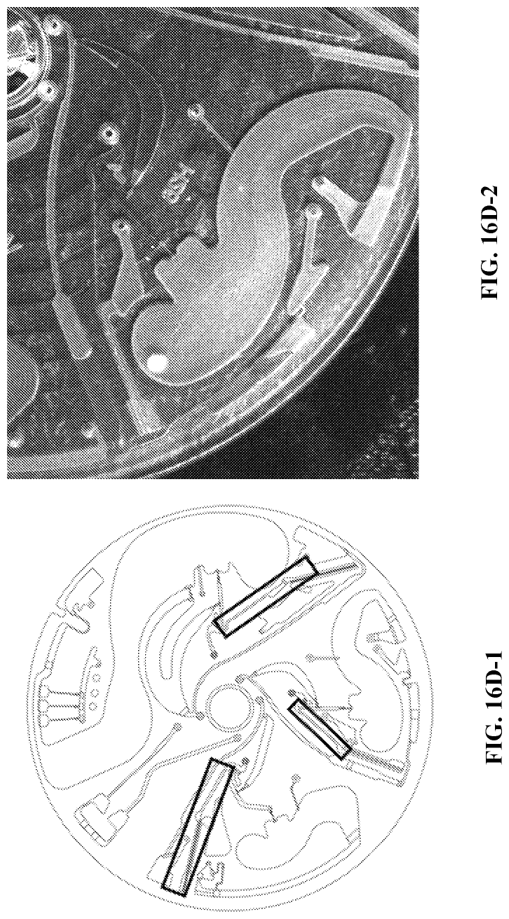

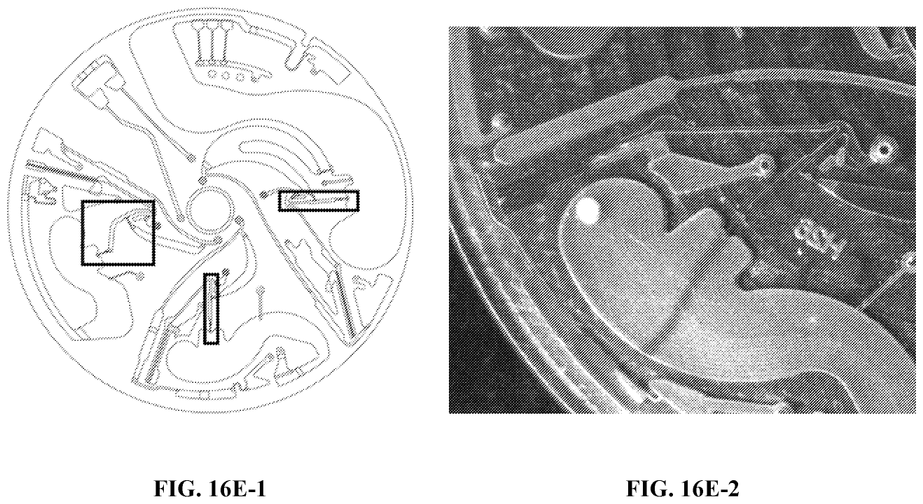

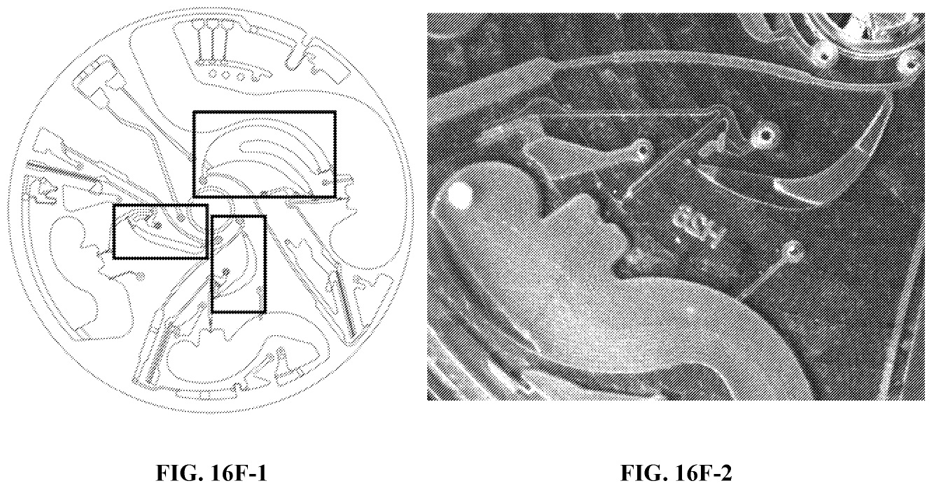

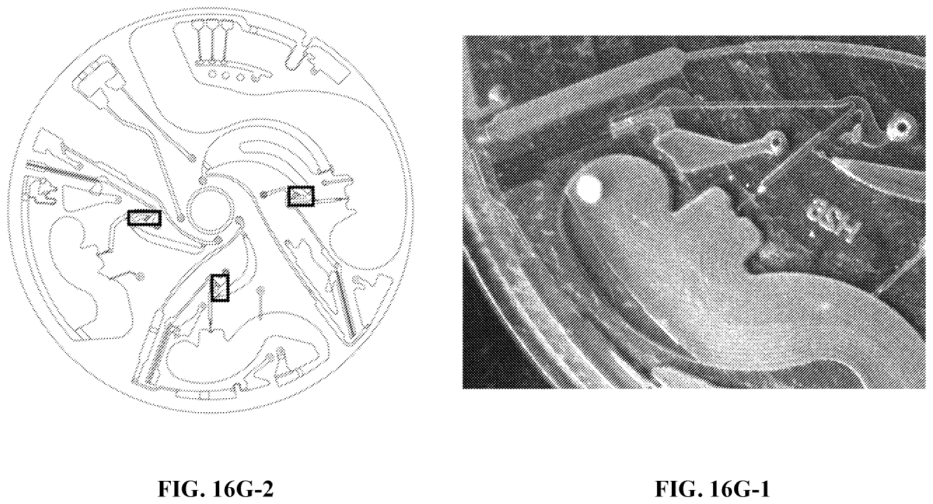

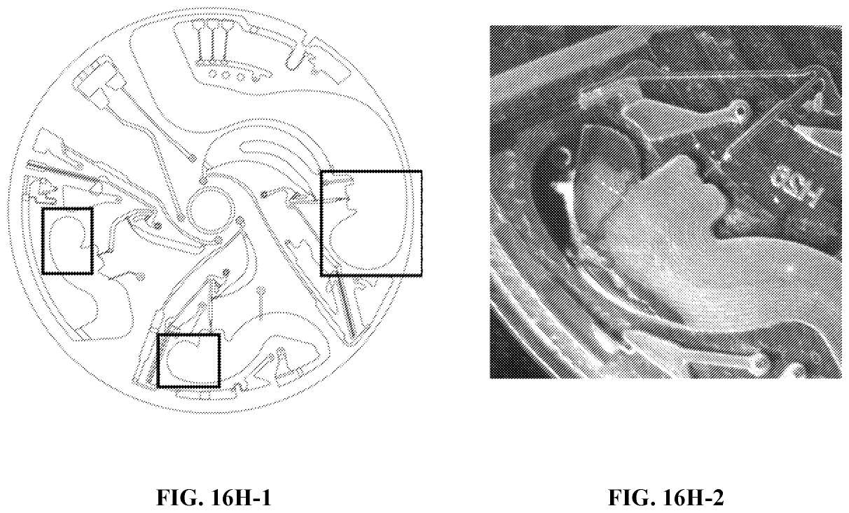

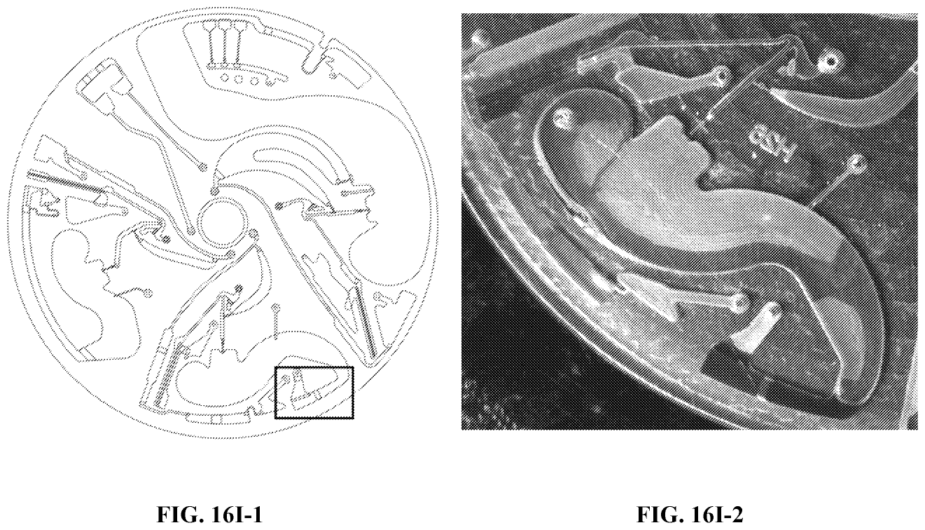

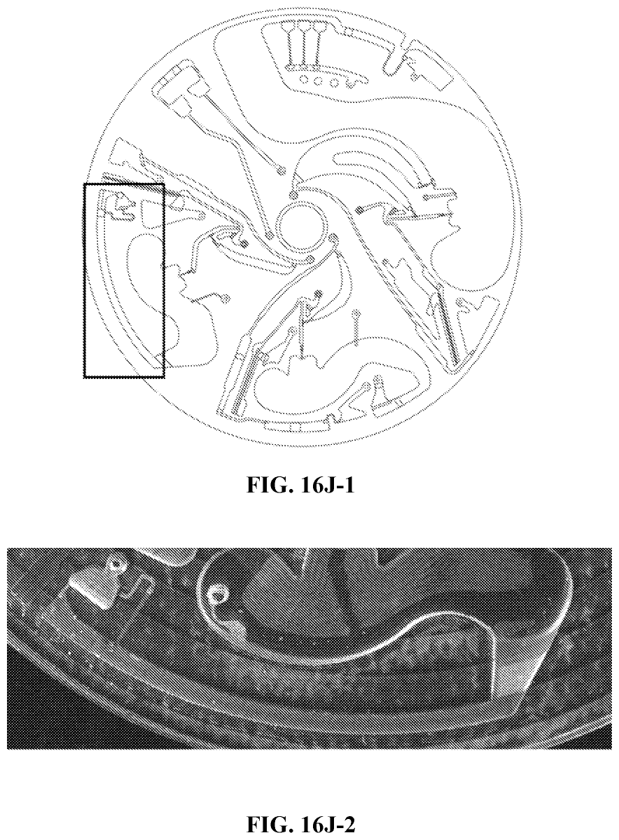

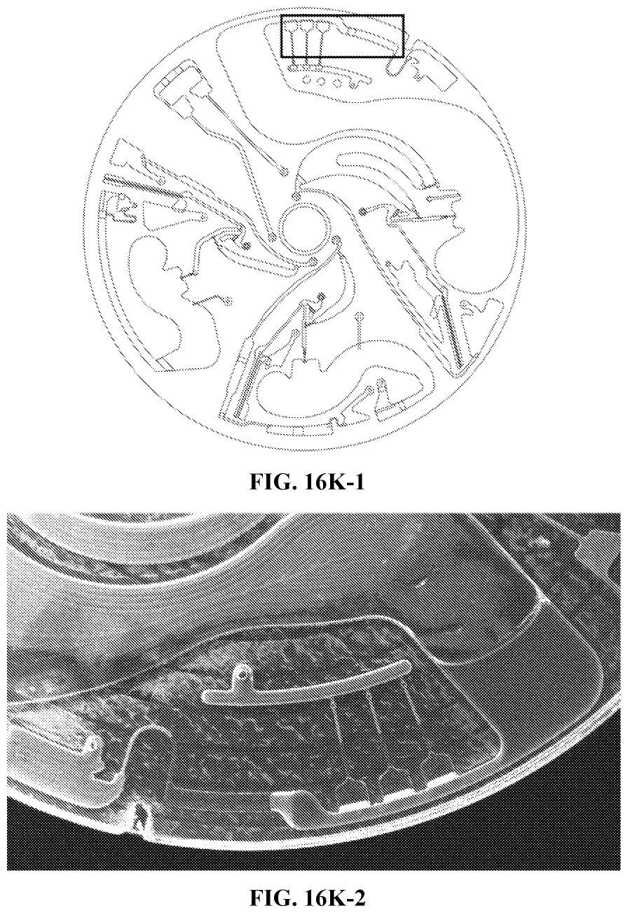

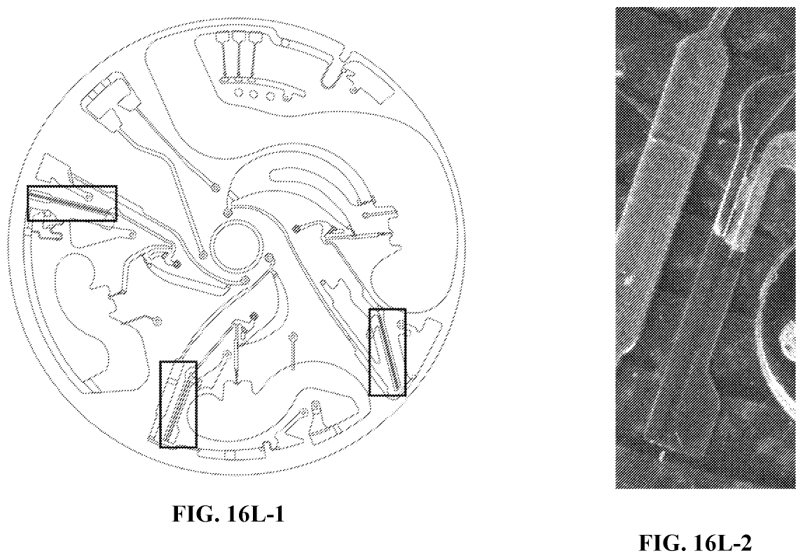

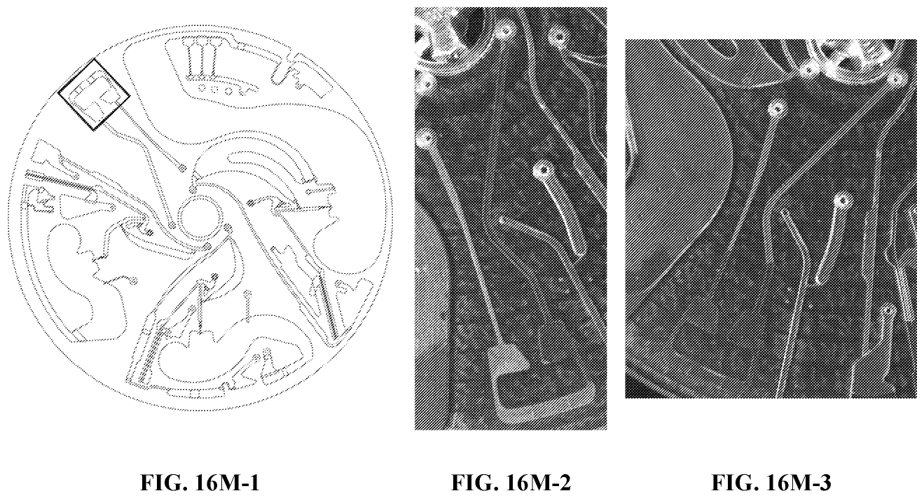

In some embodiments, the workflow 1500 includes a process 1502 that loads a buffer (e.g., water) to a device (e.g., the device 1400). The loading of the buffer may be performed when the device is stationary or rotating at a low speed. In embodiments where multiple assays are to be performed, the buffer may be loaded for all assays that are to be performed. As a non-limiting example, FIG. 16A-1 (a schematic diagram) and FIG. 16A-2 (a photograph) illustrate loading a buffer to the device 1400.

In some embodiments, the workflow 1500 includes a process 1504 that loads a sample (e.g., blood) to the device. The loading of the sample may be performed when the device is stationary or rotating at a low speed. Also, the loading of the sample may be performed prior to, concurrently with, or subsequently to the loading of the buffer. In embodiments where multiple assays are to be performed, the buffer may be loaded for all assays that are to be performed. As a non-limiting example, FIG. 16B-1 (a schematic diagram) and FIG. 16B-2 (a photograph) illustrate loading a sample (e.g., blood) to the device 1400. In some embodiments, the sample is loaded to the device, passing stepwise entrapment channel(s) (e.g., the device/structure 200 disclosed herein) for all assays.

In some embodiments, the workflow 1500 includes a process 1506 that overflows the buffer. In this process, the device (e.g., the device 1400) is spinning and in some cases, at a predefined speed profile. In embodiments where multiple assays are to be performed, the overflowing of the buffer may be performed concurrently for all assays (e.g., metering occurs at approximately the same time for all assays). As a non-limiting example, FIG. 16C-1 (a schematic diagram) and FIG. 16C-2 (a photograph) illustrate overflowing the buffer in accordance with the design of the device 1400.

In some embodiments, the workflow 1500 includes a process 1508 that overflows the sample (e.g., blood). In this process, the device (e.g., the device 1400) is spinning and in some cases at a predefined speed profile. In some embodiments, the sample is flowed or overflowed into a hematocrit column, such as a bubble-free dead-end stepwise channel (e.g., the device 700 disclosed herein). In embodiments where multiple assays are to be performed, the overflowing of the sample may be performed concurrently for all assays (e.g., metering occurs at approximately the same time for all assays). As a non-limiting example, FIG. 16D-1 (a schematic diagram) and FIG. 16D-2 (a photograph) illustrate overflowing the sample in accordance with the design of the device 1400.

In some embodiments, the workflow 1500 includes a process 1510 that meters the sample (e.g., blood). In this process, the device (e.g., the device 1400) is spinning and in some cases at a predefined speed profile. In some embodiments, during this process, a valve (e.g., the device/structure 100) is burst. The sample is directed to a mixing chamber (e.g., the device/structure 400 or the device/structure 600) via a pinched channel (e.g., the device/structure 800). In embodiments where multiple assays are to be performed, the metering of the sample may be performed concurrently for all assays (e.g., metering occurs at approximately the same time for all assays). As a non-limiting example, FIG. 16E-1 (a schematic diagram) and FIG. 16E-2 (a photograph) illustrate metering the sample in accordance with the design of the device 1400.

In some embodiments, the workflow 1500 includes a process 1512 that meters the buffer. In this process, the device (e.g., the device 1400) is spinning and in some cases at a predefined speed profile. In some embodiments, during this process, a valve (e.g., the device/structure 100) is burst. The buffer is directed to a mixing chamber (e.g., the device/structure 400 or the device/structure 600) via a pinched channel (e.g., the device/structure 800). In embodiments where multiple assays are to be performed, the metering of the buffer may be performed concurrently for all assays (e.g., metering occurs at approximately the same time for all assays). In some embodiments, in this process, a sample chamber or chambers are also flashed. As a non-limiting example, FIG. 16F-1 (a schematic diagram) and FIG. 16F-2 (a photograph) illustrate metering the buffer in accordance with the design of the device 1400.

In some embodiments, the workflow 1500 includes a process 1514 that entraps leftover sample and/or overflows the sample (e.g., blood). In this process, the spinning is accelerated (e.g., the rotational speed of the device is increased). In some embodiments, leftover sample, if any, is entrapped. In some embodiments, excess sample, if any, is overflowed to a hematocrit column. As a non-limiting example, FIG. 16G-1 (a schematic diagram) and FIG. 16G-2 (a photograph) illustrate entrapping leftover sample and/overflowing the sample in accordance with the design of the device 1400.

In some embodiments, the workflow 1500 includes a process 1516 that mixes the metered sample and metered buffer. In some embodiments, the mixing is achieved by alternately accelerating and decelerating the spinning of the device (e.g., by alternately increasing and decreasing the rotational speed of the device). Increasing/decreasing the rotational speed of the device (e.g., the device 1400) can be repeated as desired, programed, or until the solution is adequately/thoroughly mixed. In some embodiments, increasing/decreasing the rotational speed of the device may be repeated about 10 times, about 20 times, about 30 times, about 40 times, about 50 times, or about 60 times. In embodiments where multiple assays are to be performed, the volumes of the solution for different assays may be different. However, the devices (e.g., the device 1400) disclosed herein are configured such that the mixing efficiency is similar for all assays. This allows for performing the mixing for all assays concurrently (e.g., at approximately the same time and/or for approximately the same number of cycles for all assays).

In some embodiments, the mixing is conducted using an inertia motion principle, e.g., by increasing the rotational speed of the device to a threshold speed then suddenly stopping the spinning (e.g., decreasing the rotational speed to a low level or zero) as disclosed herein with respect to the device/structure 400 and the device/structure 600 thereby pushing the liquid to one side. This motion is all in one direction. This not only mixes the buffer with the sample but also dissolves the respective lyophilized reagents (e.g., lyo-beads) in the chambers. As a non-limiting example, FIG. 16H-1 (a schematic diagram) and FIG. 16H-2 (a photograph) illustrate mixing the metered sample and metered buffer in accordance with the design of the device 1400.

In some embodiments, the mixing process dissolves the lyo-bead in a mixing chamber configured for a WBC assay. The dissolved lyo-bead causes the RBC to lyse, and/or stains platelets for fluorescence imaging when desired. In some embodiments, the sample or the solution becomes translucent. In some embodiments, the WBCs are also tagged for fluorescence imaging. In some embodiments, the mixing process dissolves the lyo-bead in a mixing chamber configured for a RBC assay. In some embodiments, the dissolved lyo bead stains platelets for fluorescence imaging when desired. In some embodiments, the mixing process dissolves the lyo-bead in a mixing chamber configured for a HgB assay. In some embodiments, the dissolved lyo bead lyses all cells to get a homogeneous translucent mixture for hemoglobin absorbance measurement, for instance, by imaging and/or other methods.

In some embodiments, the workflow 1500 includes a process 1518 that delivers the mixture (e.g., the solution after the mixing process) to one or more detection channels (e.g., the device/structure 1200) for measurement. In some embodiments, the mixture is delivered to their respective imaging channels by accelerating the spinning of the device in the opposite direction (e.g., in a direction opposite to that used for mixing) to a threshold speed, then suddenly stopping to push the mixture in the direction of the spinning. In some embodiments, the device is then then spun at a low speed to allow the mixture to fill (e.g., completely fill) the one or more detection channels or chambers. As a non-limiting example, FIG. 16I-1 (a schematic diagram) and FIG. 16I-2 (a photograph) illustrate delivering the mixture to one or more detection channels in accordance with the design of the device 1400.

In some embodiments, the workflow 1500 includes a process 1520 that measures the optical density (OD) of HgB. In some embodiments, measuring the optical density (OD) of HgB is conducted using a method disclosed herein or similar methods. In some embodiments, a detection channel is a stepwise optical channel (e.g., the device/structure 1200). As a non-limiting example, FIG. 16I-1 (a schematic diagram) and FIG. 16I-2 (a photograph) illustrate measuring the OD of HgB in accordance with the design of the device 1400.

The workflow 1500 can include one or more additional, optional, or alternative processes. For instance, in some embodiments, the workflow 1500 includes a process that allows for a WBC assay (e.g., for measuring the number of white blood cells in the blood sample). In some implementations, the workflow 1500 includes an additional or optional process that allows cells to settle within one or more imaging channels that are configured for a WBC assay, as illustrated in FIG. 16J-1 (a schematic diagram) and FIG. 16J-2 (a photograph). After the cells are settled in the imaging channel(s), each of the one or more imaging channels is imaged and/or the image is analyzed for the WBC assay (e.g., the WBC count).

In some embodiments, the workflow 1500 includes a process that allows for a RBC assay (e.g., for measuring the number of erythrocytes in the blood sample). For instance, in some implementations, the workflow 1500 includes an additional or optional process that allows cells to settle within one or more imaging channels that are configured for a RBC assay, as illustrated in FIG. 16K-1 (a schematic diagram) and FIG. 16K-2 (a photograph). After the cells are settled in the imaging channel(s), each of the one or more imaging channels is imaged and/or the image is analyzed for the RBC assay.

In some embodiments, the workflow 1500 includes a process that allows for hematocrit measurement (e.g., measuring the hematocrit level or the proportion of red blood cells in the blood sample). For instance, in some implementations, the workflow 1500 includes an additional or optional process that separates plasma from the blood sample. The plasma may be separated from the blood sample (e.g., the blood sample from the sample overflow) by spinning the device at a high speed after all other assays are performed (e.g., detection channels for all other assays are imaged), as illustrated in FIG. 16L-1 (a schematic diagram) and FIG. 16L-2 (a photograph).

In some embodiments, the workflow 1500 includes a process that allows for self-calibration. The self-calibration may be performed in accordance with the method 900 and/or the device/structure 1000 disclosed herein. As a non-limiting example, FIG. 16M-1 (a schematic diagram), FIG. 16M-2 (a photograph), and FIG. 16M-3 (a photograph) illustrate a self-calibration in accordance with the design of the device 1400, which includes one or more device/structures 1000 or a structure similar to the device/structure 1000.

The devices and methods disclosed herein can be used in a variety of applications including but not limited to clinical chemistry, immunoassays and hematology. Examples of clinical chemistry, immunoassays and/or hematology are disclosed in WO2018/119437, WO2018/140719, WO2022/029731, and WO 2022/029732, the content of each application is hereby incorporated by reference in its entirety. The devices and methods disclosed herein may be operated or performed by a system similar to those disclosed in U.S. patent application Ser. No. 17/371,746, the content of which is hereby incorporated by reference in its entirety.

### Illustration of Subject Technology as Clauses

Various examples of aspects of the disclosure are described as numbered clauses (1, 2, 3, etc.) for convenience. These are provided as examples, and do not limit the subject technology.

Clause 1. A valve comprising: a first channel having a first inlet and a first outlet, wherein the first inlet is connected to an upstream chamber and has a cross-section perpendicular to a flow direction that is the same as or smaller than the upstream chamber, thereby forming a hydrophobic junction with the upstream chamber at the first inlet; and a compartment connected to the first outlet of the first channel, wherein the compartment has a cross-section perpendicular to the flow direction that is larger than the first outlet of the first channel, thereby form a hydrophilic junction at the first outlet of the first channel.

Clause 2. The valve of Clause 1, further comprising: a second channel having a second inlet and a second outlet, wherein the second inlet is connected to the compartment and the second outlet is connected to a downstream chamber.

Clause 3. The valve of Clause 2, wherein the second channel has a cross-section perpendicular to the flow direction the same as the first channel.

Clause 4. The valve of Clause 2, wherein the second channel has a cross-section perpendicular to the flow direction different than the first channel.

Clause 5. The valve of any one of Clauses 2-4, wherein the second channel is longer than the first channel.

Clause 6. The valve of any preceding Clause, wherein the compartment is deeper, wider or both than the first channel.

Clause 7. The valve of any preceding Clause, wherein the compartment is cylindrical.

Clause 8. The valve of Clause 7, wherein the compartment has a circular, oval, oblong, or polygonal cross-section.

Clause 9. A device comprising: the valve of any preceding Clause; and the upstream chamber, wherein a portion of the upstream chamber adjacent to the first inlet of the first channel of the valve is tapered to smooth transition between the upstream chamber and the first inlet of the first channel of the valve.

Clause 10. The device of Clause 9, wherein the tapered portion of the upstream chamber has a trapezoidal cross-section parallel to the flow direction.

Clause 11. The device of any one of Clauses 9-10, wherein the tapered portion of the upstream chamber is configured based at least in part on a fluid to be processed by the device.

Clause 12. The device of any one of Clauses 9-11, wherein the tapered portion of the upstream chamber has an angle of about −10 to −30 degrees, about −30 to −60 degrees, or about −60 to −80 degrees with respect to the first channel.

Clause 13. A device comprising: a rotational axis; and a channel for transferring a fluid by rotating the device around the rotational axis, the channel comprising an inlet, an outlet radially outwards of the inlet with respect to the rotational axis and a first portion between the inlet and outlet; and a structure connected to a first side of the first portion of the channel and configured to (i) allow transferring of the fluid when the device rotates at a first speed, (ii) collect fluid residue when the device rotates at a second speed that is greater than the first speed, and (iii) entrap the collected fluid residue within the structure when the device is subjected to an acceleration, a deceleration, or both.

Clause 14. The device of Clause 13, wherein the structure comprises: a pocket for containing the fluid residue; and a chamber connecting the pocket to the first side of the first portion of the channel and having a depth greater than the first portion of the channel and the pocket, thereby acting as a valve between the first portion of the channel and the pocket.

Clause 15. The device of any one of Clauses 13-14, wherein: at least a portion of the structure is positioned radially outwards of the first portion of the channel; and a radially innermost point on a junction formed by the chamber and the first side of the first portion of the channel defines a maximum permissible level for the fluid residue.

Clause 16. The device of Clause 15, wherein a second side of the first portion of the channel is positioned radially inwards of the maximum permissible level for the fluid residue.

Clause 17. The device of any one of Clauses 13-16, wherein the first portion of the channel is bent.

Clause 18. A device comprising: a rotational axis; and a mixing chamber having a curved side that is not coaxial with the rotational axis and configured for mixing a fluid with two or more different components by inertia.

Clause 19. A method comprising: (A) obtaining a device comprising a rotational axis and a mixing chamber with a curved side that is not coaxial with the rotational axis, wherein the mixing chamber contains a fluid comprising two or more different components; (B) accelerating the device to a first speed in a direction towards the curved side of the mixing chamber; and (C) decelerating abruptly the device such that the fluid moves towards the curved side of the mixing chamber due to inertia, wherein the curved side of the mixing chamber translates movement of the fluid into a circular motion that produces vortices, thereby promoting mixing of the two or more different components in the fluid.

Clause 20. The method of Clause 19, further comprising: (D) repeating the accelerating (B) and the decelerating (C) for one or more times.

Clause 21. The method of any one of Clauses 19-20, wherein the decelerating (C) brings the device to a full stop.

Clause 22. The method of any one of Clauses 19-21, wherein the decelerating (C) is performed at a deceleration of at least 500 rpm/s, at least 1000 rpm/s, at least 1500 rpm/s, at least 2000 rpm/s, or at least 2500 rpm/s, at least 3000 rpm/s, at least 5000 rpm/s, 10000 rpm/s, at least 50000 rpm/s, or greater.

Clause 23. The method of any one of Clauses 19-22, wherein a volume of the fluid is at most 50%, at most 55%, at most 60%, at most 65% or at most 70% of the mixing chamber.

Clause 24. The method of any one of Clauses 19-23, wherein the first speed is based at least in part on a type of the fluid, an amount of the fluid, a shape of the mixing chamber, or any combination thereof.

Clause 25. The method of any one of Clauses 19-24, wherein the mixing chamber comprises a pathway at a side opposite to the curved side and not coaxial with the rotational axis, the method further comprising: (E) accelerating the device at a second speed in a direction towards the pathway; and (F) decelerating abruptly the device such that the fluid moves towards the pathway of the mixing chamber due to inertia.

Clause 26. The method of Clause 25, wherein the second speed is based at least in part of a type of the fluid, an amount of the fluid, a shape of the mixing chamber, or any combination thereof.

Clause 27. A method comprising: (A) obtaining a device having a rotational axis and a chamber having a pathway that is not coaxial with the rotational axis, wherein the chamber contains a fluid; (B) accelerating the device in a direction towards the pathway of the chamber; and (C) decelerating abruptly the device such that the fluid moves towards the pathway of the chamber due to inertia.

Clause 28. A capillary channel comprising: an open end; a dead end positioned radially outwards of the open end with respect to a rotational axis; and first, second and third lanes, wherein the first lane has an inlet at the open end for receiving a fluid; the third lane has an outlet at the open end for venting air; and the second lane is formed between and connected to the first and third lanes, wherein the second lane has a flow resistance different than the first and third lanes, thereby allowing the fluid to flow first through the first lane from the open end to the dead end and then flow through the second lane, the third lane or both from the dead end to the open end to facilitate bubble-free priming.

Clause 29. The capillary channel of Clause 28, wherein the first, second and third lanes collectively form a stepwise cross-section perpendicular to a length direction of the capillary channel.

Clause 30. The capillary channel of Clause 29, wherein the first and third lanes are deeper than the second lane.

Clause 31. The capillary channel of Clause 30, wherein the first and third lanes are substantially the same as each other.

Clause 32. The capillary channel of Clause 30, wherein the first and third lanes are different from each other.

Clause 33. The capillary channel of any one of Clauses 29-32, wherein at least two of the first, second and third lanes have a same width.

Clause 34. The capillary channel of any one of Clauses 29-33, wherein at least two of the first, second and third lanes have a different width.

Clause 35. A device comprising: a rotational axis; a vent port; and the capillary channel of any one of Clauses 28-34, wherein the outlet of the third lane of the capillary channel is connected to the vent port.

Clause 36. A device comprising: a chamber; and a channel connected to the chamber for delivering a fluid to the chamber, wherein the chamber and channel collectively form a junction that minimizes or eliminates capillary flow when the fluid exits from an outlet of the channel into the chamber.

Clause 37. The device of Clause 36, wherein the channel comprises a protruding portion that forms at least a portion of the junction.

Clause 38. The device of Clause 37, wherein the protruding portion comprises a U-shaped wall on each side of the channel at the outlet of the channel.

Clause 39. The device of Clause 37, wherein the protruding portion comprises a V-shaped wall on each side of the channel at the outlet of the channel.

Clause 40. The device of any one of Clauses 36-39, wherein a wall of the chamber adjacent to the outlet of the channel is curved radially inward relative to the outlet of the channel to form at least a portion of the junction.

Clause 41. The device of any one of Clauses 36-40, wherein: the junction allows the fluid to flow from the outlet of the channel into the chamber in a direction of a centrifugal force.

Clause 42. A method comprising: (A) obtaining a device comprising a structure filled with an absorbing dye, wherein the structure comprises a first portion having a first depth and a second portion having a second depth, wherein the first and second depths are different from each other but the nominal depth difference between the first and second depths is known; (B) measuring a first optical density of the absorbing dye at the first portion of the structure and a second optical density of the absorbing dye at the second portion of the structure; (C) calculating an optical density difference between the first and second optical densities; (D) calculating a ratio of the optical density difference to the nominal depth difference, wherein the ratio represents a product of an extinction coefficient and a concentration of the absorbing dye; and (E) using the ratio to determine the first depth of the first portion of the structure, the second depth of the second portion of the structure, a depth of any additional structure of the device, or any combination thereof.

Clause 43. The method of Clause 42, wherein the obtaining (A) comprising: obtaining the device with the structure; and filling the structure with the absorbing dye.

Clause 44. A device comprising: one or more structures, each comprising a first portion having a first depth and a second portion having a second depth, wherein the first and second depths are different from each other but a nominal depth difference between the first and second depths is known, thereby allowing self-calibration of a depth of any structure of the device independent of variations in manufacturing the device.

Clause 45. The device of Clause 44, wherein the one or more structures comprises a first structure and a second structure at different locations of the device.

Clause 46. The device of Clause 45, wherein the nominal depth difference of the first structure is the same as the second structure.

Clause 47. The device of Clause 45, wherein the nominal depth difference of the first structure is different than the second structure.

Clause 48. A method comprising: (A) obtaining a device comprising a structure located in a pathway of a mixture having a first component, wherein the structure comprises a first portion having a first depth and a second portion having a second depth, wherein the first and second depths are different from each other but the nominal depth difference between the first and second depths is known; (B) measuring a first optical density of the first component at the first portion of the structure and a second optical density of the first component at the second portion of the structure; (C) calculating an optical density difference between the first and second optical densities; and (D) determining a concentration of the first component in the mixture based at least in part on the optical density difference and the nominal depth difference.

Clause 49. The method of Clause 48, wherein the concentration of the first component in the mixture is determined by comparing the optical density difference with a calibration curve at an optical pathway corresponding to the nominal depth difference.

Clause 50. The method of Clause 49, further comprising: (E) creating, prior to the determining (D), the calibration curve, wherein the creating (E) comprises: (i) preparing a series of standard solutions with known concentrations of the first component; (ii) measuring absorbance of each of the standard solutions at one or more specific wavelengths for the first component at one or more optical pathways, thereby obtaining a plurality of absorbance values; and (iii) plotting the absorbance values against the corresponding concentrations of the first component to create the calibration curve for each of the one or more optical pathways.

Clause 51. The method of Clause 50, wherein the measuring of absorbance is performed using a spectrophotometer or a microfluidics device.

Clause 52. The method of Clause 48, wherein an extinction coefficient of the first component is known; and the concentration of the first component in the mixture is calculated by dividing the optical density difference with the nominal depth difference and the extinction coefficient of the first component.

Clause 53. The method of any one of Clauses 48-52, wherein the first component is hemoglobin.

Clause 54. A device comprising: a structure located in a pathway of a mixture having a first component, wherein the structure comprises a first portion having a first depth and a second portion having a second depth, wherein the first and second depths are different from each other but the nominal depth difference between the first and second depths is known, thereby allowing measurement of a concentration of the first component independent of variations in manufacturing the device.

Clause 55. A system for operating the device or performing the method of any preceding Clause.

### TERMINOLOGIES AND REFERENCES CITED

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, “inward” or “outward” and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “include”, “includes”, “including”, “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “i^{th}” denotation, the reference number refers to a generic component, set, or embodiment. For instance, a “unit i” refers to the i^{th} unit in a plurality of units.

All references cited herein are incorporated herein by reference in their entirety and for all purposes to the same extent as if each individual publication or patent or patent application was specifically and individually indicated to be incorporated by reference in its entirety for all purposes.

What is claimed is:

1. A valve comprising:
a first channel having a first inlet and a first outlet, wherein the first inlet is connected to an upstream chamber and has a cross-section perpendicular to a flow direction that is the same as or smaller than the upstream chamber, thereby forming a hydrophobic junction with the upstream chamber at the first inlet; and
a compartment connected to the first outlet of the first channel, wherein the compartment has a cross-section perpendicular to the flow direction that is larger than the first outlet of the first channel, thereby form a hydrophilic junction at the first outlet of the first channel.

2. The valve of claim 1, further comprising:
a second channel having a second inlet and a second outlet, wherein the second inlet is connected to the compartment and the second outlet is connected to a downstream chamber.

3. The valve of claim 1, wherein the compartment is deeper, wider or both than the first channel.

4. A device comprising:
the valve of claim 1; and
the upstream chamber, wherein a portion of the upstream chamber adjacent to the first inlet of the first channel of the valve is tapered to smooth transition between the upstream chamber and the first inlet of the first channel of the valve.

5. The device of claim 4, wherein the tapered portion of the upstream chamber has a trapezoidal cross-section parallel to the flow direction.

6. A device comprising:
a rotational axis; and
a channel for transferring a fluid by rotating the device around the rotational axis, the channel comprising an inlet, an outlet radially outwards of the inlet with respect to the rotational axis and a first portion between the inlet and outlet; and
a structure connected to a first side of the first portion of the channel and configured to (i) allow transferring of the fluid when the device rotates at a first speed, (ii) collect fluid residue when the device rotates at a second speed that is greater than the first speed, and (iii) entrap the collected fluid residue within the structure when the device is subjected to an acceleration, a deceleration, or both.

7. The device of claim 6, wherein the structure comprises:
a pocket for containing the fluid residue; and
a chamber connecting the pocket to the first side of the first portion of the channel and having a depth greater than the first portion of the channel and the pocket, thereby acting as a valve between the first portion of the channel and the pocket.

8. The device of claim 6, wherein:
at least a portion of the structure is positioned radially outwards of the first portion of the channel; and
a radially innermost point on a junction formed by the chamber and the first side of the first portion of the channel defines a maximum permissible level for the fluid residue.

9. The device of claim 8, wherein a second side of the first portion of the channel is positioned radially inwards of the maximum permissible level for the fluid residue.

10. The device of claim 6, wherein the first portion of the channel is bent.

11. A method comprising:
(A) obtaining a device comprising a rotational axis and a mixing chamber with a curved side that is not coaxial with the rotational axis, wherein the mixing chamber contains a fluid comprising two or more different components;
(B) accelerating the device to a first speed in a direction towards the curved side of the mixing chamber; and
(C) decelerating abruptly the device such that the fluid moves towards the curved side of the mixing chamber due to inertia, wherein the curved side of the mixing chamber translates movement of the fluid into a circular motion that produces vortices, thereby promoting mixing of the two or more different components in the fluid.

12. The method of claim 11, further comprising:
(D) repeating the accelerating (B) and the decelerating (C) for one or more times.

13. The method of claim 12, wherein the mixing chamber comprises a pathway at a side opposite to the curved side and not coaxial with the rotational axis, the method further comprising:
(E) accelerating the device at a second speed in a direction towards the pathway; and
(F) decelerating abruptly the device such that the fluid moves towards the pathway of the mixing chamber due to inertia.

14. A method comprising:
(A) obtaining a device having a rotational axis and a chamber having a pathway that is not coaxial with the rotational axis, wherein the chamber contains a fluid;
(B) accelerating the device in a direction towards the pathway of the chamber; and
(C) decelerating abruptly the device such that the fluid moves towards the pathway of the chamber due to inertia.

15. A capillary channel comprising:
an open end;
a dead end positioned radially outwards of the open end with respect to a rotational axis; and
first, second and third lanes, wherein
the first lane has an inlet at the open end for receiving a fluid;
the third lane has an outlet at the open end for venting air; and
the second lane is formed between and connected to the first and third lanes, wherein the second lane has a flow resistance different than the first and third lanes, thereby allowing the fluid to flow first through the first lane from the open end to the dead end and then flow through the second lane, the third lane or both from the dead end to the open end to facilitate bubble-free priming.

16. The capillary channel of claim 15, wherein the first, second and third lanes collectively form a stepwise cross-section perpendicular to a length direction of the capillary channel.

17. The capillary channel of claim 16, wherein the first and third lanes are deeper than the second lane.

18. A device comprising:
a chamber; and
a channel connected to the chamber for delivering a fluid to the chamber, wherein the chamber and channel collectively form a junction that minimizes or eliminates capillary flow when the fluid exits from an outlet of the channel into the chamber.

19. The device of claim 18, wherein the channel comprises a protruding portion that forms at least a portion of the junction.

20. The device of claim 19, wherein the protruding portion comprises a U-shaped or V-shaped wall on each side of the channel at the outlet of the channel.

21. The device of claim 20, wherein a wall of the chamber adjacent to the outlet of the channel is curved radially inward relative to the outlet of the channel to form at least a portion of the junction.

22. The device of claim 21, wherein:
the junction allows the fluid to flow from the outlet of the channel into the chamber in a direction of a centrifugal force.

23. A method comprising:
(A) obtaining a device comprising a structure filled with an absorbing dye, wherein the structure comprises a first portion having a first depth and a second portion having a second depth, wherein the first and second depths are different from each other but the nominal depth difference between the first and second depths is known;
(B) measuring a first optical density of the absorbing dye at the first portion of the structure and a second optical density of the absorbing dye at the second portion of the structure;
(C) calculating an optical density difference between the first and second optical densities;
(D) calculating a ratio of the optical density difference to the nominal depth difference, wherein the ratio represents a product of an extinction coefficient and a concentration of the absorbing dye; and
(E) using the ratio to determine the first depth of the first portion of the structure, the second depth of the second portion of the structure, a depth of any additional structure of the device, or any combination thereof.

24. The method of claim 23, wherein the obtaining (A) comprising:
obtaining the device with the structure; and
filling the structure with the absorbing dye.

25. A device comprising:
one or more structures, each comprising a first portion having a first depth and a second portion having a second depth, wherein the first and second depths are different from each other but a nominal depth difference between the first and second depths is known, thereby allowing self-calibration of a depth of any structure of the device independent of variations in manufacturing the device.

26. The device of claim 25, wherein the one or more structures comprises a first structure and a second structure at different locations of the device.

27. A method comprising:
(A) obtaining a device comprising a structure located in a pathway of a mixture having a first component, wherein the structure comprises a first portion having a first depth and a second portion having a second depth, wherein the first and second depths are different from each other but the nominal depth difference between the first and second depths is known;
(B) measuring a first optical density of the first component at the first portion of the structure and a second optical density of the first component at the second portion of the structure;
(C) calculating an optical density difference between the first and second optical densities; and
(D) determining a concentration of the first component in the mixture based at least in part on the optical density difference and the nominal depth difference.

28. The method of claim 27, wherein the concentration of the first component in the mixture is determined by comparing the optical density difference with a calibration curve at an optical pathway corresponding to the nominal depth difference.

29. The method of claim 28, further comprising:
(E) creating, prior to the determining (D), the calibration curve, wherein the creating (E) comprises:
(i) preparing a series of standard solutions with known concentrations of the first component;
(ii) measuring absorbance of each of the standard solutions at one or more specific wavelengths for the first component at one or more optical pathways, thereby obtaining a plurality of absorbance values; and
(iii) plotting the absorbance values against the corresponding concentrations of the first component to create the calibration curve for each of the one or more optical pathways.

30. The method of claim 27, wherein:
an extinction coefficient of the first component is known; and
the concentration of the first component in the mixture is calculated by dividing the optical density difference with the nominal depth difference and the extinction coefficient of the first component.

31. The capillary channel of any one of claims 15-17, where a biological sample compromising of a mixture of aqueous and non-aqueous biological components is moved from an input port to an outward measurement chamber by means of inertial and centrifugal forces for analysis and assessment.

32. The capillary channel of claim 31, where the mixture is a mixture of bodily fluids and cells.
